(19) United States
(12) Patent Application Publication
(10) Pub. No.: US 2007/0124216 A1
(43) Pub. Date: May 31, 2007

(54) Systems and methods for locating and purchasing proximal inventory items

(76) Inventor: Michael Lucas, Calabasas, CA (US)

Correspondence Address: Gary M. Nath;THE NATH LAW GROUP, 112 South West Street, Alexandria, VA, 22314, US

(21) Appl. No.: 11/657,584

(22) Filed: Jan. 25, 2007

Related U.S. Application Data
(63) Continuation-in-part of application No. 10/873,183, filed on Jun. 23, 2004.
Application No. 10/873,183 is a continuation of application No. 09/799,879, filed on Mar. 7, 2001, now Pat. No. 6,996,538.
(60) Provisional application No. 60/187,389, filed on Mar. 7, 2000.
(60) Provisional application No. 60/761,757, filed on Jan. 25, 2006.

(51) Int. Cl. G06Q 30/00

(52) U.S. Cl. 705/27

(57) ABSTRACT

The inventive subject matter relates to novel systems and methods for creating and/or maintaining at least one database with availability and location information for inventory items available for sale by one or more sellers; for permitting potential customers to search, preferably in near real time, for the availability and location of such inventory items; for permitting customers to reserve, and purchase, such inventory items at location(s) of their choosing; and for permitting sellers to improve their inventory management based on customer search requests.

This application is a continuation-in-part of U.S. patent application Ser. No. 10/873,183, filed Jun. 23, 2004, which is a continuation of U.S. patent application Ser. No. 09/799,879, filed Mar. 7, 2001, now U.S. Pat. No. 6,998,538, which claims the benefit of U.S. Provisional Patent Application No. 60/187,389, filed Mar. 7, 2000, the contents of which are hereby incorporated by reference in their entirety. Further, this application claims the benefit of U.S. Provisional Patent Application No. 60/761,757, filed Jan. 25, 2006, the contents of which is hereby incorporated by reference in its entirety.

### BACKGROUND OF THE INVENTIVE SUBJECT MATTER

1. Field of Inventive Subject Matter

The inventive subject matter relates to novel systems and methods for creating and/or maintaining at least one database with availability and location information for inventory items available for sale by one or more sellers; for permitting potential customers to search, preferably in near real time, for the availability and location of such inventory items; for permitting customers to reserve, and purchase, such inventory items at location(s) of their choosing; and for permitting sellers to improve their inventory management based on customer search requests.

2. Background

In today's online commercial environment, consumer or business buyers can search for inventory items via the internet using key word searches, and are prompted to a list of domain sites (“hits”) that may, or may not, pertain to their query. On the other hand, when a buyer is searching for a specific item to purchase, the process of actually and conclusively locating the item in stock with a seller currently requires, in addition to a search using a search engine, further searching webpage-by-webpage through one or more specific domains to determine nominal product availability, and then directly contacting a store or individual person to see if the item is truly available in stock.

Thus, for example, an internet search for an inventory item executed on Goggle® or Yahoo® might yield a “hit” for an item listed at the E-Bay® website, as well as listed on particular business or individual-user website(s) which, at a time when catalogued by the search engine, listed the item as available for sale. However, there is no assurance that by the time of a query, the catalogued item is still available; indeed, it is often the case that it is not, risking that the party conducting the search will lose confidence in the ability of the putative seller to actually supply inventory items. Customer frustration is thus a significant risk in the e-commerce arena as currently structured.

Thus, for example, E-Bay® utilizes a bidding process which provides information showing the availability for purchase and current bid for an item; and if the item is already sold, provides information showing the that the item was listed; has been sold, and at what date and time; the sales price; and to whom. E-Bay® also provides a “buy it now” feature, which shows item availability and a fixed price, for those consumers who want to purchase the inventory item without going through a bidding process.

The major search engines (e.g. Google®, MSN, Yahoo®) have made the search for information simple. A user simply logs into the search domain site, enters a word or phrase to be searched, and related domain pages are prompted, usually within a second or less. Users can also use advanced search methods for narrowing the scope of a search. In any case, whether following a “link” into one of the first domains advertised on the first search results page, or later in the search results, users must often engage in the exhausting effort of conducting a webpage-by-webpage search for the inventory item or particular information they are seeking.

Search engines generate revenue by contracting with consumers or businesses to prompt linking, or “clicking through,” to information on sponsored links or to highlighted domain name links displayed on completion of a search. Advertisers may “purchase” particular keywords, and upon the use of such words in searches conducted by users, sponsored links are placed in the search results displayed, according to the placement fee paid by the advertiser, generally on the basis that the higher the placement, the higher the fee. Revenue to the search engine operator is paid based upon the quantity of “clicks” generated, i.e. “cost per click”. In any case, accurate and current information relating to an inventory item is maintained on a separate database, lacking search access or permission granted to the search engine. Thus, current search engines notably lack a feature which can search for a specific product which is in stock and available for sale.

After the filing of the parent U.S. Provisional Patent Application No. 60/761,757, a number of so-called “online local search” services have been launched, including NearbyNow, ShopLocal, Slifter, StepUp Commerce, Yokel, Slingshot, and others. To some degree, these services provide search functionality which is in part similar to the inventive subject matter, although none provide the full range of features and benefits of the claimed systems and methods.

Thus, the inventive subject matter addresses the deficiencies in the prior art by providing a potential buyer of an inventory item with the ability to locate the item in stock and within a specified proximity to a location of the buyer's choosing.

It will be readily apparent to one of ordinary skill in the art that the inventive subject matter requires access to the inventory databases of multiple manufacturers, suppliers, distributors, retailers, other sellers, or a combination thereof. With appropriate permissions and roles, multiple individual company databases, shared databases, or both can be searched. In one aspect of the inventive subject matter, such multiple or shared databases are as described in Applicant's U.S. patent application Ser. No. 09/799,879, filed Mar. 7, 2001, the entire contents of which is hereby incorporated by reference in its entirety.

### SUMMARY OF THE INVENTIVE SUBJECT MATTER

The inventive subject matter relates to a method for facilitating sales of inventory items, comprising the steps of:

(a) maintaining at least one database having information relating to an inventory item,
wherein said inventory item is listed by a plurality of sellers, and
wherein said information comprises at least availability information and location information for said inventory item, which is available for sale from at least one seller;

(b) permitting a buyer to input a search request to generate a search in said database(s) for current availability and current location of such inventory item; and

(c) generating a search result which provides said buyer with information comprising the availability and location of an inventory item which is actually available for sale by one or more sellers.

The inventive subject matter further relates to a method for facilitating sales of inventory items, comprising the steps of:

(a) maintaining at least one database having information relating to an inventory item,
wherein said inventory item is listed by a plurality of sellers,
wherein said inventory item is tracked by an RFID-enabled inventory tracking system, and
wherein said information comprises at least availability information and location information for said inventory item, which is available for sale from at least one seller;

(b) permitting a buyer to input a search request to generate a search in said database(s) for current availability and current location of such inventory item; and

(c) generating a search result which provides said buyer with information comprising the availability and location of an inventory item which is actually available for sale by one or more sellers.

The inventive subject matter also relates to a system for facilitating sales of inventory items, comprising the following elements, operably connected:

(a) at least one database, in which at least the following data is stored: availability and location information for at least one inventory item, listed by a plurality of sellers;

maintaining at least one database having information relating to an inventory item,

wherein said inventory item is listed by sellers as being available for sale, and
wherein said information comprises at least availability information and location information for said inventory item, which is available for sale from at least one seller;

(b) software providing an interface for initiating a search request by a buyer;

(c) software for providing access to a search engine for executing said search request in at least one database;

(d) software for processing a search request and providing a search result comprising the availability and location of such inventory item which is actually available for sale by one or more sellers; and

(e) software for providing an interface for displaying the result of the search of said at least one database.

### BRIEF DESCRIPTION OF THE DRAWINGS

FIG. 1 is a drawing which depicts an exemplary screen shot of a search bar in one embodiment of the inventive subject.

FIG. 2 is a series of three drawings which depict exemplary screen shots of search result list generated in one embodiment of the inventive subject.

FIG. 3 is a drawing which depicts an embodiment in which a customer conducts a search of the inventory information of multiple retailers, according to one aspect of the inventive subject matter.

FIG. 4 is a drawing which depicts an embodiment in which a customer conducts a search of the inventory information of multiple manufacturers, according to one aspect of the inventive subject matter.

FIG. 5 is a drawing which depicts an embodiment in which a customer conducts a search of the inventory information of multiple distributors, according to one aspect of the inventive subject matter.

FIG. 6 is a drawing which depicts an embodiment in which a customer conducts a search of the inventory information of multiple suppliers, according to one aspect of the inventive subject matter.

FIG. 7 is a drawing which depicts an advanced inventory search features screen shot, according to one aspect of the inventive subject matter.

FIG. 8 is a drawing which depicts a search function in which one or more search engine server(s) communicate directly with one or more inventory database server(s), which in turn communicate directly with a plurality of inventory databases maintained by manufacturers, suppliers, distributors, retailers, other sellers, or a combination thereof, according to one aspect of the inventive subject matter.

FIG. 9 is a drawing which depicts a search function in which one or more search engine server(s) communicate directly with one or more inventory database server(s) search stored, cumulated inventory information, according to one aspect of the inventive subject matter.

FIG. 10 is a drawing which depicts a search function in which one or more inventory database server(s) communicate directly with a plurality of inventory databases maintained by manufacturers, suppliers, distributors, retailers, other sellers, or a combination thereof, according to one aspect of the inventive subject matter.

FIG. 11 is a drawing which depicts a search function in which one or more inventory database server(s) search stored, cumulated inventory information, according to one aspect of the inventive subject matter.

FIG. 12 is a drawing which depicts a search function in which one or more search engine server(s) communicate directly with a plurality of inventory databases maintained by manufacturers, suppliers, distributors, retailers, other sellers, or a combination thereof, according to one aspect of the inventive subject matter.

FIG. 13 is a drawing which depicts a search function in which one or more search engine server(s) search stored, cumulated inventory information, according to one aspect of the inventive subject matter.

### DETAILED DESCRIPTION OF THE INVENTIVE SUBJECT MATTER

### Definitions

The term “seller” as used herein refers broadly to any one or more of manufacturers, suppliers, distributors, retailers, private party individuals, and other entities or persons which exchange, or promote the exchange, of goods and/or services for money, or goods and/or services in kind.

The term “available for sale” as used herein refers broadly to offering an item to be sold or making an item available viewing by potential purchasers. The term is not limited to items subject to an unconditional offer to sell which may be accepted by a buyer, but in the context of the inventive subject matter also relates to soliciting offers to buy which require seller acceptance.

The term “buyer” as used herein refers broadly to a purchaser, customer, consumer, prospect, shopper, manufacturer, supplier, distributor, or retailer, whether actual or potential. Thus, the term “buyer” as used herein encompasses both the serious shopper ready to purchase, as well as the “virtual window shopper.” In the context of the inventive subject matter, a “user” of the inventive systems and methods is also a “buyer” as that term is used herein.

The term “inventory item” as used herein refers broadly to goods that are available for sale, barter, or lease from a person or entity; raw materials; works in process; or materials used or consumed in a business.

The term “multiple item search request” as used herein refers to a search request which is preferably structured to search a database, based on a single search request, for multiple related inventory items, such as searching for all parts related to an inventory item which has replaceable parts.

### The Inventive Subject Matter

The inventive subject matter relates to novel systems and methods for creating and/or maintaining at least one database with availability and location information for inventory items available for sale by one or more sellers; for permitting potential customers to search, preferably in near real time, for the availability and location of such inventory items; for permitting customers to reserve, and purchase, such inventory items at location(s) of their choosing; and for permitting sellers to improve their inventory management based on customer search requests.

Consumer and business buyers alike can benefit from a search engine that searches the inventory of multiple manufacturers, suppliers, distributors, retailers, other sellers, or combinations thereof; locates a particular inventory item for sale from one or more manufacturers, suppliers, distributors, retailers, other sellers, or combinations thereof within a set proximity to the buyer's current or desired location; and provides the ability to reserve an inventory item for pick-up (within a time allotment for pick-up determined by the seller) or, with an approved payment method, provides for purchasing and delivery of the item. Similarly, businesses and other sellers who have an inventory item for sale, new or used, can post the availability of the inventory item and the location where the inventory item is stored or available for pick-up.

In addition to the benefits of the inventive subject matter to be enjoyed by inventory item buyers, the inventive systems and methods also provide significant benefits to sellers. In one embodiment, sellers may optionally adjust database parameters to limit reservations which may be accepted for particular inventory items, and optionally obtain event notifications when a search for their item is made. These data can be used to assist in improving inventory management, particularly to facilitate timely ordering and avoiding out-of-stock situations. In addition, such data can be used by sellers in forecasting inventory usage.

In an alternate embodiment of the inventive subject matter, in addition to, or instead of, text-based item descriptions which are searchable using conventional text searching, photographs or drawings of inventory items can be stored as digital images, and an inventory search may be conducted by comparing a captured image of a desired item to a library inventory item digital images stored in said database(s).

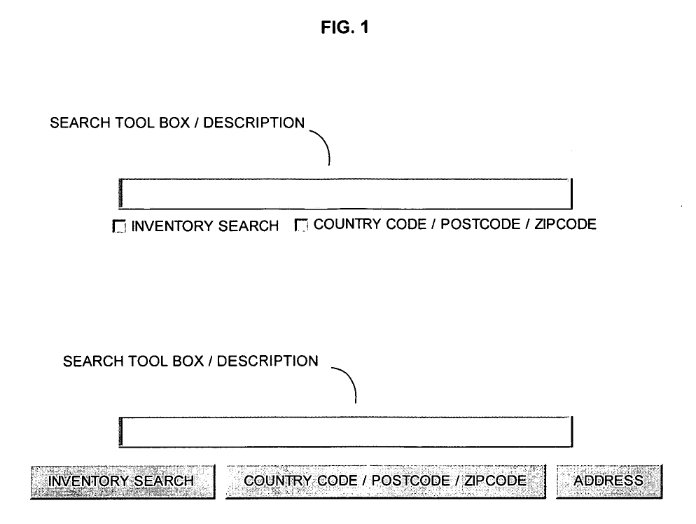

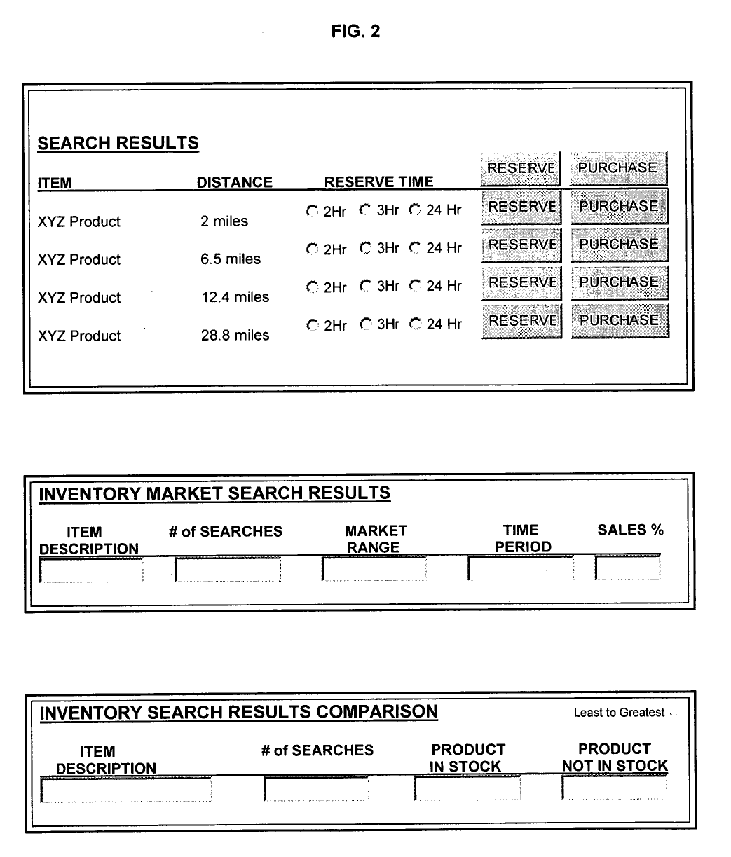

As shown in exemplary FIG. 1, when a consumer or business makes a query for a product, utilizing a search interface similar to those used by current search engines, the user would input the description of the item they are seeking to locate or purchase; “click” or “check” a box for an inventory search; enter the user's locator information such as zip code, postal code, address, or telephone number; and “enter” (from a typical computer) or “send” (from a typical mobile telephone or other handheld wireless device). This would optionally bypass the current database search structure because of the unique location search criteria, thus filtering out or bypassing entirely the advertised sites or prompted domains that would be found through a general search criteria. Such a search would pull information, if any, on the location of the item and the proximity of that item from the user zip code or other locator. As shown in exemplary FIG. 2, information is optionally displayed about the retailer or other seller so provided.

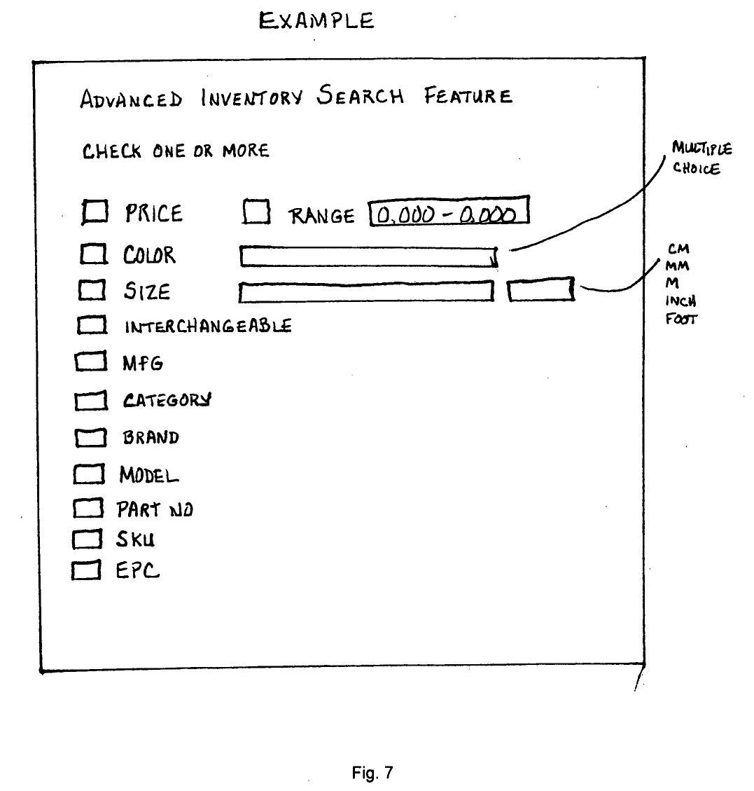

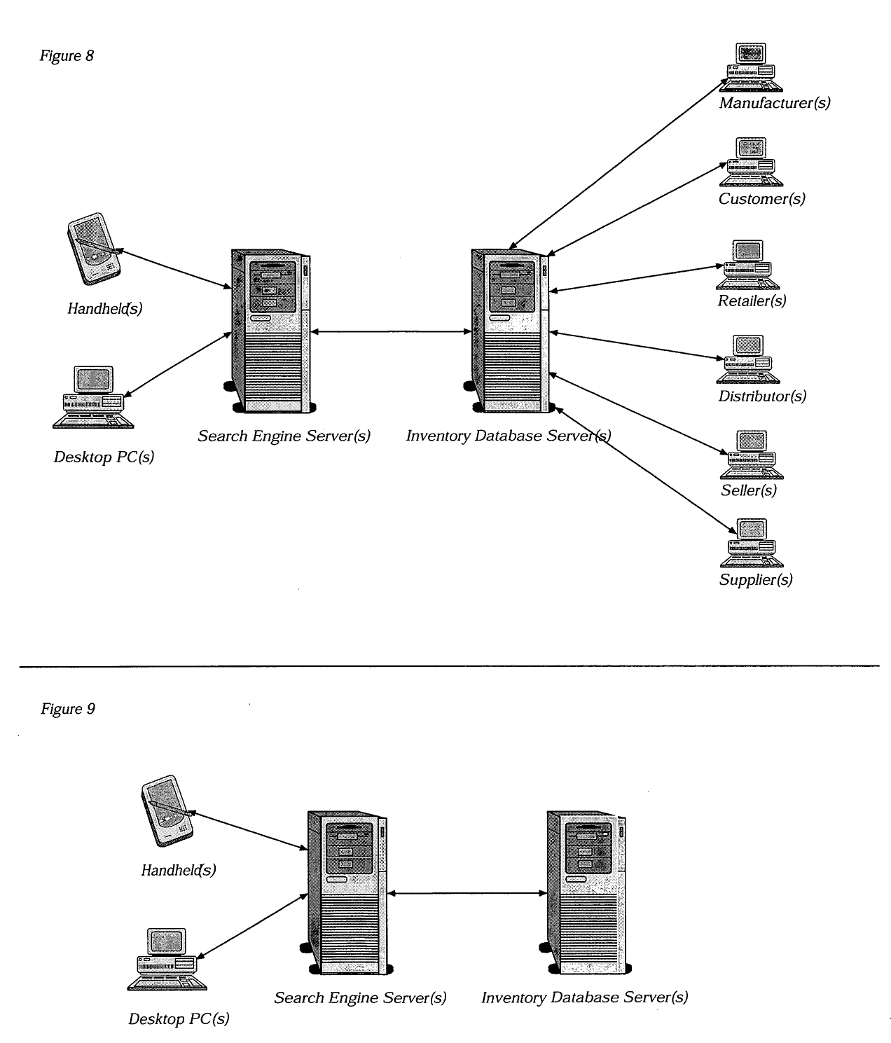

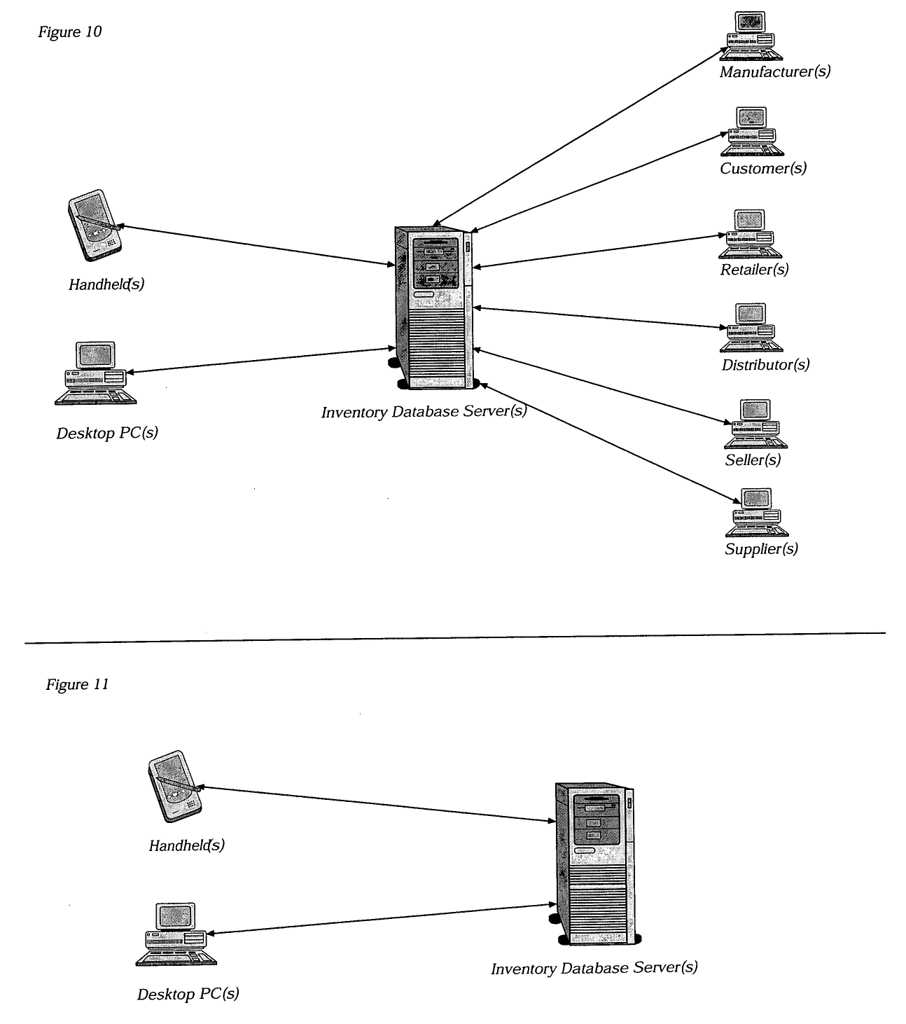

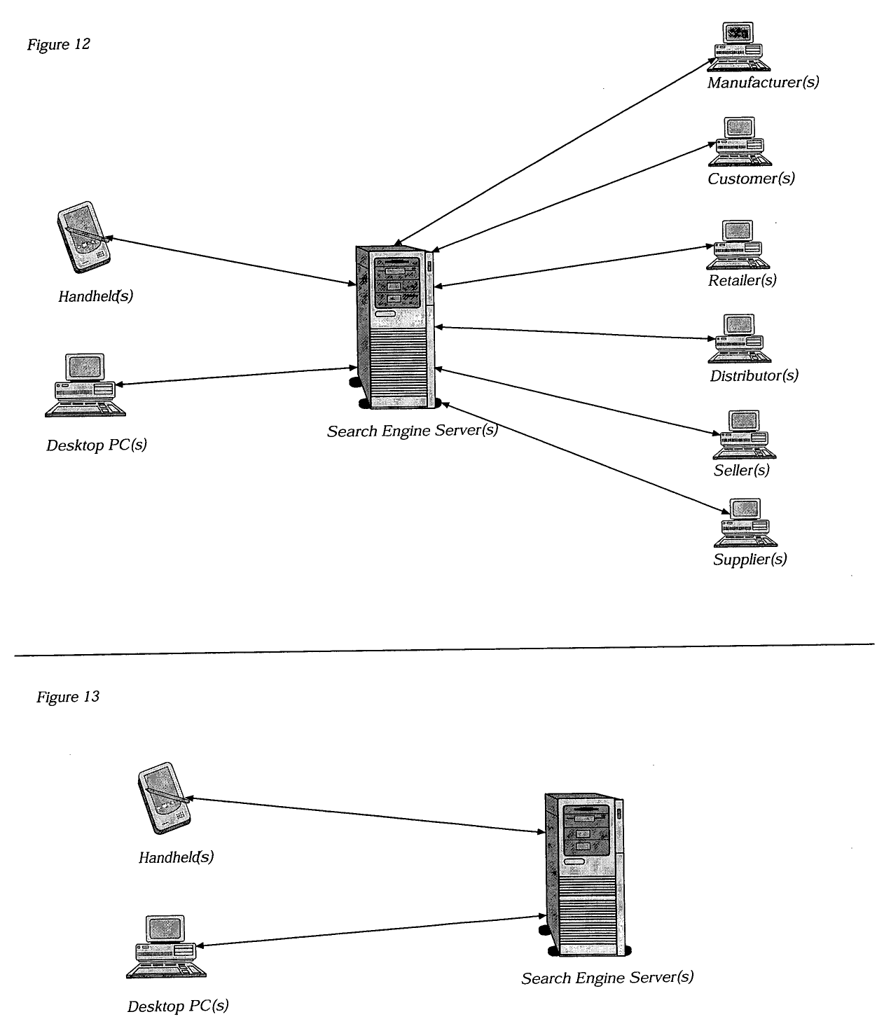

As shown in exemplary FIG. 7, in one aspect of the inventive subject matter the database for the inventory item may include information relating to manufacturer and/or vendor, product category and sub-category (if applicable), particular item SKU (if applicable), item description, model or part number, electronic product code, and the like. Additional advanced search functions may include, for example, item size, color, material, and the like.

In another aspect of the inventive subject matter, users would then have the ability to reserve an item for a specified time, with the allowance of reserve time defined by the retailer/seller, and hold the item for pick-up. The system would preferably generate a reservation confirmation, such as a number with the users information provided, and submit information to the retailer/seller to reserve the item. In the case of a retailer, a reservation confirmation would preferably prompt store personnel to remove the item from the sales floor or in some fashion mark the item as “reserved” for internet customer.

In one embodiment, many retailers would be able to seamlessly update inventory data in real time, as items are removed or added to inventory, using, for example, existing Point of Sale systems or RFID-enabled inventory tracking systems.

In an alternate embodiment, other retailers without web-based point of sale systems, such as small to medium sized companies and individuals, would still be able to log onto the internet to post items for sale to an inventory database, and receive e-mail alerts, fax or other form of communication when a user has reserved a particular item posted.

A major advantage in the marketplace maintained by so-called “brick and mortar” stores is the ability to provide instant consumer gratification. A prospective buyer can walk into a store, find and purchase an inventory item, and have immediate possession and use of the item.

On the other hand, internet-based buying, often called e-commerce, provides convenience: the ability to shop from the comfort of home, office, or wherever the buyer is located (and has internet access), and to have the inventory item delivered to the buyer's choice of location. However, for buying situations in which the buyer needs or wants immediate possession and use of the inventory item, current online buying methods are unsatisfactory.

Except in extraordinary circumstances, online orders are not received by the buyer until at least the next business day, and only at considerable cost for expedited shipping and handling. For the immediate, “must-have” inventory item, the traditional “brick and mortar” store still provides the only immediate access.

Some large chain stores now provide a “store pick-up” option for inventory items located via their proprietary websites, giving the buyer the option to order via an “on-line store” for shipping to the buyer or to order and reserve an inventory item for subsequent pick-up at a store. However, these proprietary features are available only to direct users of the proprietary website, not a search engine, and search only the database of a single seller, not multiple sellers.

Yet reliance on physical stores still suffers a major deficiency in providing information to buyers relating to inventory items: the need for the buyer to search online, to call multiple stores, or worse yet, to drive from store to store to find an item in stock, to fully compare similar items, and to obtain price-comparisons.

Thus, what is lacking in the traditional, real world shopping experience is the ability to determine real-time inventory availability from multiple sellers, without visiting or calling multiple stores, or checking multiple websites.

Similarly, from the buyer's perspective what is lacking in the virtual, online shopping experience is the ability to conduct a comprehensive inventory search of multiple inventory item sellers, to determine real-time inventory availability, and to examine the look and feel of an inventory item prior to purchase.

### Inventive Methods

Thus, the inventive subject matter relates to a method for facilitating sales of inventory items, comprising the steps of:

(a) maintaining at least one database having information relating to an inventory item,
wherein said inventory item is listed by a plurality of sellers, and
wherein said information comprises at least availability information and location information for said inventory item, which is available for sale from at least one seller;

(b) permitting a buyer to input a search request to generate a search in said database(s) for current availability and current location of such inventory item; and

(c) generating a search result which provides said buyer with information comprising the availability and location of an inventory item which is actually available for sale by one or more sellers.

In one aspect of the inventive subject matter, said method comprises the additional step of permitting said buyer to reserve, purchase, or reserve and purchase said inventory item at a location of said buyer's choosing.

The inventive subject matter may be implemented using an index server which is operably connected to a plurality of databases which, for example, store inventory data from a variety of sellers.

In another aspect of the inventive subject matter, said database is updated in near real time to actual, current availability and current location information for said inventory item.

In another aspect of the inventive subject matter, said search request is generated automatically through a software interface to a third party database.

In another aspect of the inventive subject matter, said information further comprises price information for said inventory item.

In another aspect of the inventive subject matter, said information further comprises a price range for said inventory item.

In another aspect of the inventive subject matter, said information further comprises a description of one or more feature(s) of said inventory item.

In another aspect of the inventive subject matter, said location information is restricted to a specified proximity limit in relation to a specified location. Such a location is optionally specified by the user or determined in relation to the location of, for example, devices such as a mobile telephone or other wireless device, a computer, a land line telephone, a kiosk such as an ATM, and the like.

In a preferred embodiment, said specified location is restricted by zip code, postal code, country code, telephone area code, address, or a combination thereof.

In another preferred embodiment, said specified location is determined by a GPS device. For example, the GPS locator function of a mobile telephone or other wireless device can be used to determine fairly precisely the location of the device and its user. It is expected that such location information will be sufficiently accurate to enable use of a specified proximity limit in relation to the GPS-identified location.

In another aspect of the inventive subject matter, said information further comprises identification of alternate items which are interchangeable with said inventory item.

In another aspect of the inventive subject matter, said inventory item is tracked by an RFID-enabled inventory tracking system.

In a further aspect, said buyer's search request is restricted according to limited or unlimited permissions, roles, or authorizations assigned by said seller.

In addition to facilitating a buyer locating an inventory item in stock and nearby, the inventive methods benefit sellers as well. Thus, sellers may reduce inventory “turns”, reduce stock-on-hand and the corresponding capital investment in such inventory, better define replenishment strategy and criteria, and set ordering parameters. In this aspect of the inventive subject matter, the method comprises the additional steps of:

(d) storing said buyers' search requests;

(e) generating an items searched report compiling information relating to said buyers' search requests; and

(f) providing said report to one or more of said sellers.

In a preferred embodiment, the inventive method comprises one or more of the following additional steps:

(g) forecasting the inventory needs of a seller based on inventory usage, inventory availability trends, said items searched report, or a combination thereof;

(h) ordering inventory for a seller based on inventory usage, inventory availability trends, said items searched report, or a combination thereof;

(i) presenting advertising to a buyer based on inventory usage, inventory availability, market trends, said items searched report, or a combination thereof;

(j) providing a seller incentive offer to a buyer based on inventory usage, inventory availability, said items searched report, or a combination thereof; or

(k) a combination thereof.

The inventive methods further comprise the aspects and embodiments as described above, additionally comprising tracking of said inventory item by an RFID-enabled inventory tracking system.

### Inventive Systems

The inventive subject matter further relates to a system for facilitating sales of inventory items, comprising the following elements, operably connected:

(a) at least one database, in which at least the following data is stored: availability and location information for at least one inventory item, listed by a plurality of sellers;

maintaining at least one database having information relating to an inventory item,

wherein said inventory item is listed by sellers as being available for sale, and
wherein said information comprises at least availability information and location information for said inventory item, which is available for sale from at least one seller;

(b) software providing an interface for initiating a search request by a buyer;

(c) software for providing access to a search engine for executing said search request in at least one database;

(d) software for processing a search request and providing a search result comprising the availability and location of such inventory item which is actually available for sale by one or more sellers; and

(e) software for providing an interface for displaying the result of the search of said at least one database.

In one aspect of the inventive subject matter, said system further comprises the additional element of software providing an interface for permitting said buyer to reserve, purchase, or reserve and purchase said inventory item at a location of said buyer's choosing.

In another aspect of the inventive subject matter, said database is updated in near real time to actual, current availability and current location information for said inventory item.

In another aspect of the inventive subject matter, said search request is generated automatically through a software interface to a third party database.

In another aspect of the inventive subject matter, said search result further comprises price information for said inventory item.

In another aspect of the inventive subject matter, said search result further comprises a price range for said inventory item.

In another aspect of the inventive subject matter, said search result further comprises a description of one or more feature(s) of said inventory item.

In another aspect of the inventive subject matter, said location information is restricted to a specified proximity limit in relation to a specified location.

In a preferred embodiment, said specified location is restricted by zip code, postal code, country code, telephone area code, address, or a combination thereof.

In another preferred embodiment, said specified location is determined by a GPS device.

In another aspect of the inventive subject matter, said search result further comprises identification of alternate items which are interchangeable with said inventory item.

In another aspect of the inventive subject matter, said inventory item is tracked by an RFID-enabled inventory tracking system.

Once a user of a search engine locates a particular site the user was seeking, the user could simply add it to their “favorites” list and avoid the step of searching in the future. In addition to the other features and benefits described herein, the inventive subject matter effectively requires that users return to a search engine to search for a specific inventory item, thus protecting the revenue model of search engines.

Another value to the retailers or sellers is that they could receive reports as to the number of “inventory searches” made whereby they had the inventory in-stock then conduct a comparative analysis as to whether they are getting their market share or not. Thus the inventive system comprises the additional elements of:

(d) memory, and software providing an interface for storing said search requests;

(e) software for generating an items searched report which compiles information relating to said search requests; and

(f) software providing an interface for providing said items searched report to one or more of said sellers.

In a preferred embodiment, the inventive system comprises one or more of the following additional elements:

(g) software for forecasting the inventory needs of a seller based on inventory usage, inventory availability trends, said items searched report, or a combination thereof;

(h) software for ordering inventory for a seller based on inventory usage, inventory availability trends, said items searched report, or a combination thereof;

(i) software providing an interface for presenting advertising to a buyer based on inventory usage, inventory availability, market trends, said items searched report, or a combination thereof;

(j) software providing an interface for providing a seller incentive offer to a buyer based on inventory usage, inventory availability, market trends, said items searched report, or a combination thereof; or

(k) a combination thereof.

The retailers or sellers could limit their inventory searches to interested buyers (consumers, etc) within a specific distance radius. For example, while it may be unlikely that someone will drive 25 miles to pick up a DVD, it is reasonably likely that someone may drive 100 miles to pick up a specific auto part necessary to complete the reconstruction of a classic car.

A consumer could follow the previous protocol for an inventory search, input the maker a particular part and a part number or input the SKU if known and the name of the manufacturer and the search could find the replacement part the consumer or business is searching for. Many consumers have had the experience, for example, of visiting various office supply stores searching for the right toner for their laser printer, or home improvement stores searching for the water filter replacement for a specific appliance manufacturer, or called around searching for tires to see if they are in stock and the prices. This process eliminates the unnecessary time wasted in your car, on the telephone searching for the item. The search query will show all of the inventory available within a predetermined selected mile radius of the users zip code entered. If the party doesn't select a zip code then the results will show numerous, if any, results in the shortest proximity of the user zip code. If the user wants to input his/her address after locating a particular item a secondary page will provide the exact distance from the users home/business address to the location chosen. Another feature would be to provide details of the seller, such as store hours an policies. This feature would be available if requested by the inquirer.

Advancement of technology leads to improved item locating. Small to medium sized business may not elect to implement RFID, however, larger stores have already began to implement RFID throughout the supply chain. As individual items begin to be tagged at the item level, RFID will provide accurate up to the second information on availability of the product to the end user seeking a particular item in a search. The user goes through the protocol outlined on the previous e-mail and can reserve the particular item depending on the store rules. A SKU which is identified by an optical scanner (barcode reader) does not communicate with a data server as to whether the item is actually in stock or the location of the item. The inventory item is deleted from inventory when the item is involved in the POS (Point of Sale) transaction. At this time the item is then deleted and in some cases not updated into a database until after store closing hours or perhaps even at the end of the week. The use of RFID in this case provides an “in stock report” so long as the item is still on the shelf. For example, a consumer walks into a retail store and picks up an item off the shelf and walks away. This item is no longer available as it has been pulled by a consumer and is intended to be sold at the completion of his or her shopping. That item for example would not be available at that moment for reservation because the probability of the consumer purchasing the item is high. The database could be updated the moment the item is removed from the shelf depending on the antenna range of the RFID reader. Readers are placed in proximity and a store planning system can be used to manage the location, bin or shelf of the item. Although, RFID has not been implemented on individual items on a large scale, the cost of the RF tags can be used on items that have a higher value and items without RFID would have a separate business protocol for reserving items for consumers requesting such reservation. In this case, a reservation number is generated and sent to the retailer (seller). The seller could then be prompted to remove the item from the shelf and place the item in customer service for reservation customers.

Smaller businesses with minimal retail space have fewer employees, fewer inventory items and less customer traffic so the importance of RFID is not as effective. In this environment, small businesses can easily identify (most of them know) the inventory location and reserve the item for the customer.

The adoption of this technology is available because the inventory data is being submitted by a plurality of manufacturers, wholesalers, distributors, retailers or consumers through a centralized inventory data hub server. As inventory data is deleted, added or transferred the data is synchronized with the central data hub server to provide accurate up to the minute information for users.

A reservation of the item or purchase order created by the user for the item provides the user with the agreed upon time limit to pick up the order from the seller. In the event the item is on display, the seller can place an identifier on the item as “item reserved for internet customer—reservation number match required”. This protects the buyer or interested party by having the seller request the reservation number, by inputting the unique or special code, the name of the party is presented with other data for verification.

In addition to the basic features described above, the inventive system optionally comprises the additional elements of memory, and software providing an interface for a buyer to save, retrieve, and re-initiate an individual search request made by said buyer. This feature provides a buyer with the ability to search repeated for rare or unusual items, as well items purchased regularly.

Finally, the inventive system optionally provides an interface for initiating a multiple item search request by a buyer. Thus, for example, customers of the OnStar® network receive regular vehicle status updates from General Motors. When such a report indicates the need for vehicle service, the inventive systems provide for multiple item search request in order to locate a number of parts required for servicing a complete vehicle system, such as the belts, hoses, and other wear-items that are replaced during “major” vehicle service.

This application has many benefits to various businesses and consumers. Included below are examples of the businesses or inventory items that could benefit from use of the inventive subject matter, some of which are described in the representative examples following:

Automotive—New and Used

Electronics

New releases of DVD's or CD's

Tires/Wheels

Automotive Parts

Office Supplies such as toner

Replacement parts for Appliances such as filters, etc

Wine (Vineyard/Year)

Home improvement items

Toys

Livestock

Pharmaceuticals (Prescription Drug Availability)

### EXAMPLES

The following examples are illustrative of the inventive subject matter and are not intended to be limitations thereon.

### Example 1

### Enhancing Vehicle-Based Search Systems

The following example illustrates enhancing a vehicle-based search system, according to the inventive subject matter. General Motor's On-Star® locator system is representative of search functions found on vehicles. The system currently permits searching for, among other things, particular types of businesses such as dry cleaners, theaters, restaurants, and the like. Enhanced by addition of the search capabilities of the inventive subject matter, vehicle-based locator systems may assist in locating inventory items in proximity to a vehicle, thus enhancing the ability of the vehicle operator to more efficiently locate and purchase such items.

### Example 2

### Enhancing Home Improvement Product Searching

The following example illustrates enhancing home improvement product searching, according to the inventive subject matter. The Home Depot® website provides a search function for ordering home improvement products online. It does not provide for searching store inventory, nor does it provide inventory availability for its physical stores. In the instance of a tradesperson or homeowner searching for an item to complete a job on the same day as procuring needed products, the Home Depot® website is thus essentially useless.

Enhanced by addition of the search capabilities of the inventive subject matter, such a tradesperson or homeowner is assisted in locating inventory items in proximity to a convenient location, thus enhancing the ability of the tradesperson or homeowner to more efficiently locate and purchase needed items.

### Example 3

### Enhancing Auto Parts Search Systems

The following example illustrates enhancing a auto parts search system, according to the inventive subject matter.

Current auto parts search systems are restricted to searching only for parts suppliers which provide assurance that a particular part can be made available within a set period of time, usually not less than one business day. Such systems cannot locate in stock parts. In the instance of a mechanic or vehicle owner searching for an item to complete a job on the same day as procuring needed parts, current auto parts search systems are essentially useless. Enhanced by addition of the search capabilities of the inventive subject matter, such a mechanic or vehicle owner is assisted in locating inventory items in proximity to a convenient location, thus enhancing the ability of the mechanic or vehicle owner to more efficiently locate and purchase needed items. Auto parts search systems can be further enhanced by the use of inventory searches conducted by comparing a captured image of a desired item to a library inventory item digital images stored in said database(s).

### Example 4

### Enhancing Procurement of Prescription Drugs

The following example illustrates enhancing a search system for locating a prescription drug or a generic equivalent, according to the inventive subject matter. Current prescription drug search systems are generally restricted to searching only proprietary databases. Such systems cannot, for example, locate in-stock drugs at a location most convenient to a physician's office or a patient's home or work. In the instance of an ill person searching for medication to follow a physician's directions to begin treating a medical condition immediately, current drug search systems are of limited usefulness. Enhanced by addition of the search capabilities of the inventive subject matter, a physician or patient is assisted in locating branded drugs or their generic equivalent if available in proximity to a convenient location, thus enhancing the treatment of the patient. Prescription drug search systems can be further enhanced by the use of inventory searches which identify alternate drugs or generic equivalents which are interchangeable with a prescribed drug.

### Example 5

### Preferred Inventory Management Systems and Methods

The following example illustrates a preferred inventory management system which is optionally used to create and maintain the at least one database having information relating to an inventory item, as described in detail herein.

### Background of Preferred Inventory Management

Traditionally, inventory control has been done by the company or organization using the items in the inventory. In smaller offices, inventory control is typically not a high priority, and orders may be placed whenever items are out of stock.

As an office increases in size, inventory management becomes more of a challenge, and monitoring of frequently used or crucial items becomes very important. Typically a person is given the responsibility of monitoring inventory and ordering replacements as supply diminishes. As a company further increases in size, more advanced inventory management techniques may be used. For example, supply and usage trends may be analyzed to determine minimum quantities on hand, and seasonal or other peak usage may be determined.

Some larger offices have switched to automated or semi-automated inventory tracking systems. These automated systems utilize barcode scanners or other electronic identifiers to track outgoing and incoming inventory, and can prepare purchase requests as supplies diminish.

### Summary of Preferred Inventory Management

The present invention improves upon the prior art by shifting the burden of inventory tracking onto a third party; this concept is referred to as vendor managed inventory, or VMI. When a third party provides VMI services for multiple companies, it gains significant buying power which it can use to negotiate better deals, improve supplier responsiveness, and streamline the buying process.

The present invention allows third-parties to monitor company inventory via the Internet and World Wide Web (“web”) In addition, the present invention allows small to medium sized companies to take advantage of VMI by providing a cost-effective solution to their inventory tracking needs.

The present invention utilizes web-enabled technologies to revolutionize inventory management by tracking inventory and automatically contacting suppliers, manufacturers, or distributors when additional supplies are needed. This may result in a labor reduction as compared to the labor-intensive inventory maintenance systems currently deployed.

In addition to reducing labor costs, the present invention may help a company cut other costs. The present invention may help reduce delivery costs by regularly ordering supplies in anticipation of need, thus obviating the need for express shipments. The present invention may also allow third parties to take advantage of manufacturer or distributor specials when offered for the products its customers require, thus further reducing customer cost.

While purchasing is a large part of inventory maintenance, the present invention may also facilitate other transactions as well. For example, the present invention may allow customers to resell products or equipment to other businesses, thereby maximizing utility. Although some in the prior art, such as Neoforma.com and Medibuy.com, have attempted to provide business-to-business equipment resale through web-based auctions, auctions do not provide equipment availability assurances. The present invention provides a forum through which resellers and customers may interact, where the present invention acts as a broker, thereby assuring both that purchased equipment is delivered, and that a seller receives proper compensation.

### Detailed Description of the Preferred Inventory Management

The present invention implements an Internet-based, vendor managed inventory (“VMI”) system. A VMI system allows a customer to reduce costs by pushing inventory management responsibilities onto a third party, or manager. Managers may service multiple companies, thus allowing them to negotiate better deals, improve supplier responsiveness, and serve as an effective customer advocate.

The present invention allows managers to inexpensively monitor customer inventory via the Internet and World Wide Web (“web”). The present invention utilizes web-enabled technologies to revolutionize inventory management by tracking inventory and automatically contacting suppliers, manufacturers, or distributors when products are needed. This may result in a labor reduction as compared to the labor-intensive inventory maintenance systems currently deployed.

FIG. 1 is a block diagram illustrating the major hardware components of the present invention. As illustrated in FIG. 1, the present invention utilizes a client/server architecture to facilitate communication between customer inventory systems and managers. A client running on a Customer Inventory System 130 may be used to track inventory, place special orders, and interact with other customers.

A client may include custom software, such as an application written in Visual Basic, JAVA, or C; commercial software, such as a web page accessible through a web browser; or a combination of custom and commercial software, such as a “plug-in” which operates in a web browser. Examples of common web browsers include Internet Explorer, developed by Microsoft Corporation of Redmond, Wash., and Navigator, developed by Netscape Corporation of Mountain View, Calif.

Customer Inventory Systems 130 may allow manual inventory tracking, semi-automated inventory tracking, or inventory may be dispensed using automated systems. By way of example, without intending to limit the present invention, a preferred embodiment of the present invention includes a handheld device, such as a Palm VII device by Palm Computing, Inc., to be outfitted with a barcode scanner. Such a device can allow barcodes or other identifiers associated with each inventory item to be scanned or otherwise entered into the system prior to or at the time of item distribution. As each item is scanned, a count maintained by the present invention may be adjusted to properly track inventory levels. Recipient-specific labels, including product warnings and other information, can then be printed for each scanned item.

Other inventory distribution methods contemplated include, but are not limited to, interfacing the present invention with vending machines. Vending machines may allow accurate inventory tracking without requiring human interaction, except to periodically restock a particular supply or group of supplies. In a preferred embodiment, vending machines may include security measures to prevent unauthorized supply distribution.

Such security measures may include, but are not limited to, the use of an identification card and personal identification number (“PIN”), and biometric systems. Vending machines equipped with security systems may restrict access to specific supplies on an individual-by-individual level, or group-by-group basis. Vending machines may also be equipped with label printers that allow warnings and other information to be attached to a dispensed item's packaging.

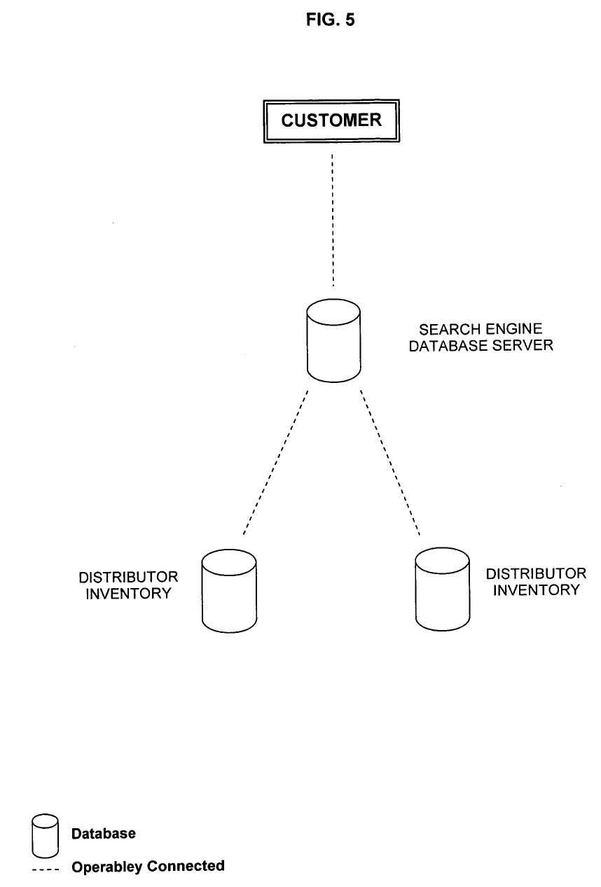

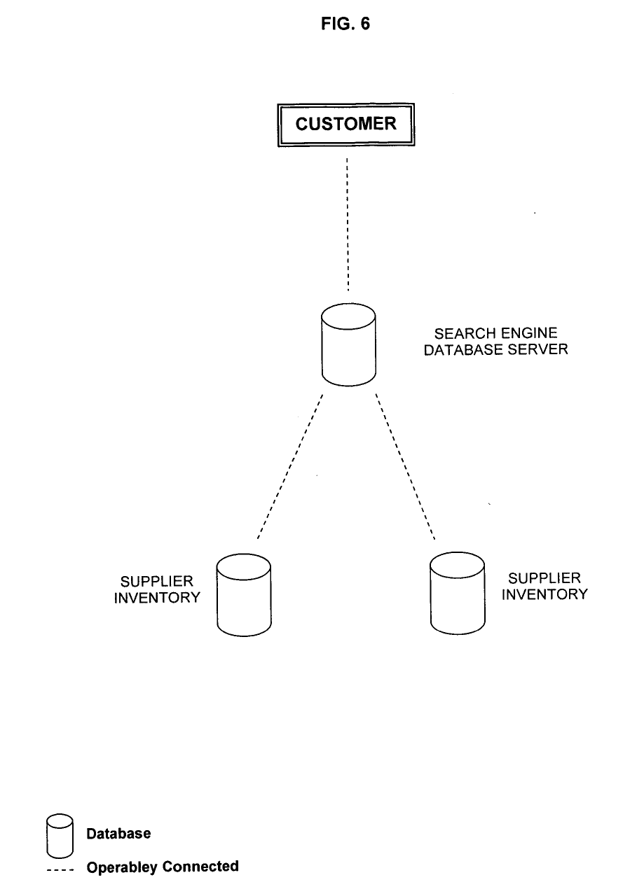

Alternatively, supply closets or other storage areas can be outfitted with a Radio Frequency Identification (RFID) portal, as illustrated in FIG. 5. An RFID portal (Block 500) is similar in structure to airport security metal detectors, except that RFID portals can detect or scan RFID tags as such tags pass through a portal. The present invention can monitor RFID tag identifiers, including identifiers assigned to individuals, such that access to a storage area can be monitored, and items removed by an individual can be tracked without any direct user interaction.

A preferred embodiment of the present invention can also track individual product dispensation, and may require additional information as products are dispensed. By way of example, without intending to limit the present invention, if a doctor dispenses sample medication to a patient, the present invention may also request a patient identifier, whereas if a package of gauze bandages was removed from inventory to restock an examination room, the present invention may not request a patient identifier. Patient identifiers can be used by the present invention to generate dispensation history reports for various products which may help suppliers and manufacturers to better understand income, race, ethnicity, or other demographic characteristics of typical recipients. The present invention may restrict such reports to only demographic information, and may not include individual-specific information in such reports.

An alternative embodiment of the present invention allows physicians or others to carry a handheld device through which prescriptions can be written while talking with a patient. Such a handheld device can connect to a local inventory management system through a wireless or wired means, and, when appropriate, a prescribed item sample may be automatically dispensed by a vending machine. Alternatively, a message may be displayed at a nurse's station indicating the items to be pulled from inventory. When items are dispensed by a vending machine or pulled from inventory, inventory counts can be decremented as appropriate, and new orders can be placed as necessary.

As inventory is distributed, Customer Inventory System 130 may track supply usage habits to determine minimum acceptable quantities on-hand. Usage information may be studied for various periods of time, and the present invention may create an inventory usage model based on collected data. As models are created and refined, the present invention may modify minimum in-stock thresholds to reflect anticipated usage. As quantity in-stock approaches a calculated or specified threshold, Customer Inventory System 130 may automatically request new supplies from Server 100. Supply requests may include various information, including, but not limited to, urgency of request, customer willingness to accept alternative brands or sizes, billing information, and shipping information.

As Server 100 receives supply requests, Server 100 may request price quotes from several Manufacturer, Supplier, or Distributor 120's (“Distributor 120”). Distributor 120 may respond with quantity available, price, estimated delivery time, and other such information. Server 100 may then automatically evaluate each Distributor 120 response to find the best value given various factors associated with each customer request. When an appropriate Distributor 120 response is chosen, Server 100 may automatically arrange payment and shipping of requested supplies for Customer Inventory System 130.

Communication between Customer Inventory System 130, Server 100, and Distributor 120 may be achieved through various methods, including, but not limited to, hypertext transfer protocol (“HTTP”), file transfer protocol (“FTP”), simple mail transfer protocol (“SMTP”), or other such related methods.

Although purchasing is a large part of inventory maintenance, a preferred embodiment of the present invention may also facilitate communication between customers, provide a source of information dissemination, and encourage customer interaction. The present invention may facilitate customer communication by allowing customers to resell products, equipment, or excess inventory to other businesses. The present invention may allow information dissemination by providing an up to date catalog of available equipment and other inventory from which a customer may order. The present invention may facilitate customer communication by allowing managers and customers to author and distribute articles describing new rules, regulations, procedures, revenue generation prospects, or other information of interest to other customers.

Customer Inventory System 130 may serve as the primary source of customer interaction with the present invention. Articles, catalogs, inventory information, and other such information may be stored on Server 100, and Customer Inventory System 130 may communicate with Server 100 to obtain requested information.

FIG. 2 illustrates a preferred embodiment of Server 100, in which relationships between data storage, web server, and application services provided by Server 100 are illustrated. All client communications may first pass through Firewall 210. Firewall 210 represents a combination of software and hardware which is used to protect the data stored in Web Server 220, Database Server 230, and Application Server 240 from unauthorized access.

As previously described, clients may communicate with the present invention through various protocols, including HTTP. Web Server 220 represents software capable of transmitting and receiving information via HTTP or other protocols. Examples of such software include Internet Information Server, developed by Microsoft Corporation of Redmond, Wash.; Enterprise Server, developed by Netscape Corporation of Mountain View, Calif.; and Apache Server, developed by the Apache Software Foundation of Forest Hill, Md.

When a client requests information, Web Server 220 may determine whether a client request requires pre-processing, in which case a request is transferred to Application Server 240, or if a request simply requires data to fulfill the request, in which case Web Server 220 may communicate directly with Database Server 230.

Database Server 230 represents commercially available database software, such as Microsoft SQL Server, developed by Microsoft Corporation of Redmond, Wash., Oracle 8i, developed by Oracle Corporation, of Redwood Shores, Calif., or other, similar software. Database Server 230 may store raw data, such as customer inventory information, customer addresses, vendor names, vendor product classes, and other such similar information. Such information may be transmitted to a client by Web Server 220, or Application Server 240 may interpret information stored in Database Server 230 prior to transmission.

Application Server 240 may contain business rules associated with the present

invention, which can be used to interpret Database Server 230 data prior to transmission of that data to a client. In addition to interpreting information stored in Database Server 230 for client use, Application Server 240 may also monitor inventory levels reflected in Database Server 230, contact vendors based on information from Database Server 230,

adjust inventory information as new inventory is received, and provide the services necessary to facilitate business-to-business resale of equipment or products stored in Database Server 230.

Web Server 220, Database Server 230, and Application Server 240 each represent software which may run on the same computer, or on multiple computers. In addition, Application Server 240 may be implemented within Database Server 230 as a set of business rules.

An alternative description of the present invention follows, in which the present invention is described through a series of functional specifications. This information is included for enablement purposes, and describes the best mode contemplated at the time the present specification was filed. While the following functional specification describes a preferred embodiment of the present invention, descriptions within the functional specification should not be construed as limiting the present invention.

To avoid confusion, the following terms are used in this functional specification:

Customer—Refers to a buyer of products via the present invention. Customers can have “open account” relationships to avoid credit card and COD shipment problems.

Linked Supplier—A distinction is made to avoid confusion with other vendors doing business with the present invention, given that payables may be in a common accounts payable system. Distributors, manufacturers, or other vendors (collectively “suppliers”), are distinguished by whether they are using the present invention's inventory tracking and accounting software, and therefore have live Internet linkages into their databases for queries, order processing, and billing.

Manual Supplier—If a supplier provides goods or services through the present invention, but tracks inventory through a manual interface, such a supplier may be termed a “Manual Supplier”. Open account relationships may be maintained between Linked or Manual Suppliers avoid payment complexities.

Non-linked Supplier—Suppliers not linked to the present invention.

Products—Items for sale via the present invention.

Customer Inventory—A list of products to be maintained at a given customer site.

In addition to the general definitions set forth above, this functions specification also defines a set of system functions. System functions may fall into one of the following general sub-system categories:

Interactive—human interface and related functions for tracking inventory counts, inventory consumption rates, ordering critical products, and the like. Interactive processes may be web-based or PC-based (client-server).

Nightly Processes—periodic processes through which orders can be generated and invoicing and related processes can be performed, including interaction with Distribution system at distributor warehouses.

Corporate—processes performed within corporate offices, but which update a database. Includes accounting, client data management, and other such processes.

Distribution—Linked Suppliers integrated with the present invention. Industry standard Enterprise Resource Planning (ERP) software may be bundled with commercial financial software to provide a complete business system to Linked Suppliers.

Database Design—A database schema which may be utilized in a preferred embodiment of the present invention.

The present invention in general, and this functional specification specifically, defines styles and functions included in detailed web pages and other user interface elements that are intended to be available system wide. Web pages, application windows, program screens, and transactions within the present invention should observe common rules. These rules include, but are not limited to:
No customer can view, inquiry into, update or in any way alter another customers data. Transactions can use an IP address or other unique identifier as a cross-check against a customer ID coming in with transmitted pages to insure rule enforcement. For such security procedures, customer IP addresses or other unique identifiers may only be changed through a function accessible only to Corporate staff.
No Linked Supplier can see data belonging to another linked supplier.
System parameters controlling customer options can be set through an account setup and editing process. Such a process may be accessed by only someone with an authorized identifier. Initially, such identifiers may only be given to Corporate Staff.
Data changes will generally be reflected by a transaction log or transaction history, which may be accessible to customers or distributors, and to which Corporate Staff with appropriate security levels may have access.

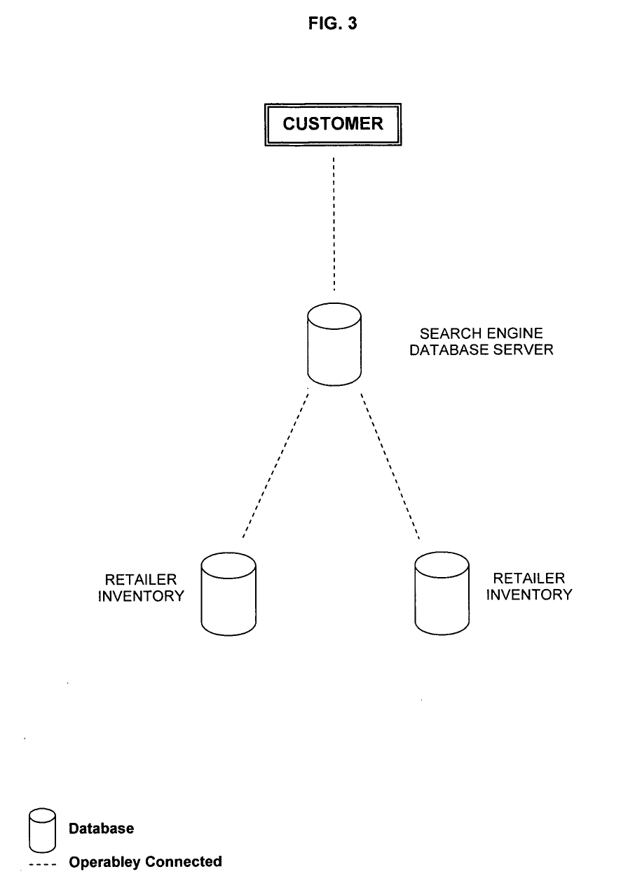

Functions involving data changes may be performed as server-side scripts, rather than through client-side logic. In general, such server-side scripts can utilize a logical flow similar to FIG. 3. As FIG. 3 illustrates, client software running on a customer machine may generate a page containing data to be updated by a web server and transmit said page to said web server (Block 300).

When a web server receives a page from a customer machine, the present invention may attempt to process any changes requested by said page. If such changes are successful (Block 320), the present invention may return a confirmation page or cause a confirmation message to be displayed to a customer machine, and appropriate transaction logging may occur.

If changes are not successful, the present invention may increment a retry count by one (Block 340). If the retry count is less than or equal to three, the present invention may retransmit customer changes (Block 370) to Block 310 in an effort to make any appropriate changes. If the retry count exceeds three (Block 350), the present invention may cause a page containing any error codes or other feedback information to be displayed on a client machine. Such a page may also contain original client data changes as well as a means for resubmitting said changes (Block 360).

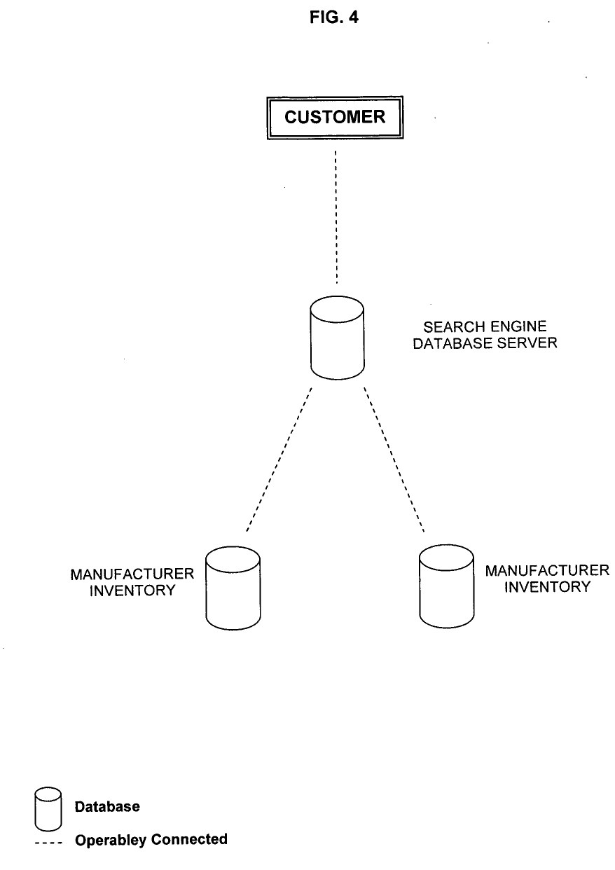

Client software may also periodically verify that a data connection exists between said client software and a server acting as part of the present invention. Such software may follow the logic illustrated in FIG. 4 to achieve accurate data connection monitoring. As Block 400 illustrates, client software may send one or more TCP/IP Ping commands or other network test commands to verify that a high-speed connection is still available to a server acting as part of the present invention.

If a high-speed network connection is detected, the present invention can continue normal operations (Block 410). If a high-speed network connection is not detected, the present invention may attempt to reestablish such a connection (Block 420). If a high speed network connection can be reestablished (Block 430), the present invention may continue normal operations (Block 410). If a high-speed network connection cannot be established, a lower speed network connection, such as a dial-up network connection, may be established by the present invention (Block 440). If a lower speed network connection can be established, the present invention may continue normal operations, including periodically attempting to reestablish a high-speed network connection (Block 410).

If a lower speed network connection cannot be established, client software may display an application or page with alternative user interface and alternative functionality (Block 460). Such alternative functionality can include local storage of product usage information, local inventory tracking, and limited reordering via a dial-up or other temporary connection with a known supplier (Block 470). A client functioning without a data connection may periodically attempt to reestablish high or low speed network connections (Block 480). When a connection is reestablished (Block 490), a client may transmit product usage scan information to a server acting as part of the present invention.

In addition to an inventory tracking application, the present invention may also utilize a high speed network connection to transmit new product offerings or special promotions to a client for display to a customer. As new products are entered into a Products table or similar data structure, the present invention may cause such a product to appear on a client. In a preferred embodiment, the present invention may allow customers to select products in which a customer is interested, and the present invention may only display new products or special deals meeting a customer's prior specifications. Such specifications can include, but are not limited to, categories by manufacturer, product trade name, specific product type, general product classification, and quantity available or quantity per shipping unit.

A client displaying such information may allow a customer to indicate an interest in a product by typing a command, clicking a button or other graphical interface element, or otherwise interacting with said client. If a customer expresses an interest in a featured product, a client may allow a customer to create a one-time order, or to configure recurring orders.

In addition to allowing customers to record product usage and order new inventory or new products, client software may also display advertisements on a rotating basis, and may be used for other purposes. A typical client software screen may also contain additional information and fields; including, but not limited to, a Product SKU field, a User-ID field, a Doctor-ID field, and a Sales Consultant Contact field.

When customers are not directly interacting with client software, client software may place a cursor in a Product SKU field by default. Placing a cursor in a Product SKU field can allow client software to ready accept an automatically or manually entered product identifier, such as a barcode label scanned via a wedge-style bar-code scanner.

As product identifiers are entered, client software may request a User-ID for each product identifier or set of product identifiers. A User-ID is a unique identifier created for each employee or set of employees within an organization. Such identifiers may be entered manually through an active user interface, such as, but not limited to, a keyboard, touch screen, or number pad, or through a passive user interface, such as, but not limited to, biometric recognition equipment, barcode identifiers worn by or associated with an employee, or through RFID tags worn by or associated with an employee. User-ID's may be combined with passwords to create a more secure inventory tracking system.

User-ID's may be used to track persons removing items from an inventory, but additional tracking or other controls may also be desirable. For example additional authorization may be required when employees remove expensive items or controlled substances from an inventory. The present invention may recognize when such an inventory item is removed, and client software may request an additional identifier, called a Doctor-ID, as authorization. Client software may even allow any user to enter a Doctor-ID for some inventory items, while for other inventory items a Doctor-ID and related password may be required. A biometric or other positive identifier may be used in place of a Doctor-ID or Doctor-ID and password in some applications.

When appropriate inventory tracking data has been entered into client software, the present invention may transmit such data to a server. A server may send a confirmation message to a client upon receipt of such data. If a confirmation message is not received within a predetermined period of time, the present invention may resend inventory tracking data. If successive resend attempts are unsuccessful, the present invention may follow a process similar to that illustrated by FIG. 3. Client software may allow additional inventory scans to occur while waiting for confirmation from a server.

In addition to recording inventory tracking information, client software may also allow a customer to access various options. Such options may include, but are not limited to, an administrative page, an inventory status inquiry page, and an inventory receipt page. An administrative page can allow authorized customers to create, edit, or remove User-ID's, Doctor-ID's, groups of such accounts, and account-specific information. An inventory status inquiry page can retrieve and display a page containing customer inventory records, order status, and other such information.

An inventory status inquiry may be initiated through client software, which can send a page containing customer-specific information, as well as site-specific identification information stored on a client machine. In a preferred embodiment, a server receiving such a request may select records with appropriate site- and user-specific information from a table of customer inventory records. A server may generate a page or screen containing customer inventory information, including information from several tables. Table 1 below provides an example of columns displayed on a typical inventory request screen, as well as sample table and field names from which such data can be drawn.

TABLE 1

| Column Heading | Source Table | Source Field |
|---|---|---|
| Description | PRODUCTS | DESCRIPTION |
| Product | CUSTOMER_INVENTORY | PRODUCT |
| Quantity In Stock | CUSTOMER_INVENTORY | ON_HAND_QTY |
| Order Point | CUSTOMER_INVENTORY | ROP |
| ReOrder Quantity | CUSTOMER_INVENTORY | ROQ |
| Activity Status | CUSTOMER_INVENTORY | STATUS |

An advantage of the present invention over the prior art is the ability to simplify adding new items or restocking items into an inventory. Linked Suppliers shipping goods to a customer can provide a specially coded packing list, and a customer can automatically or manually enter such a code into client software. Client software can validate a packing list number as belonging to a customer and ensure a packing list is not credited to a customer system more than once. Entry of an invalid or previously validated packing slip can cause client software to display an error message.

If a valid packing slip is entered, client software may retrieve shipment contents from a centralized database or from a supplier database, and automatically update customer inventory information to reflect inventory received. Client software may then display a message confirming successful inventory changes, and return a customer to a main page.

A product search page may also be accessible through client software. A product search page can allow a user to select a search type and, if appropriate, search parameters and search parameter values (collectively “search criteria”). By way of example, without intending to limit the present invention, a product search page may allow a customer to search by specific manufacturer and products of a certain classification.

When a customer has selected appropriate search criteria, client software may pass such search criteria to a server. A server may query a database of products and product descriptions and return products matching or approximating customer search criteria.

If a user has selected a descriptive search, a server may select records from a Products table, or other similar table, whose data matches or approximates descriptive text entered by a user. If a user has selected a parameter search, a server may select Product table records whose fields match or approximate user search requests. To expedite such selections, a server may index descriptions, manufacturers, product classes, product names, and other frequently searched fields.

When appropriate records are selected, a server may transmit such records to client software for display. Client software may present such records in a variety of formats, including, but not limited to, a columnar or tabular format. Table 2 lists sample column names, sample source table names, source field names, and additional functionality client software may present when displaying such records.

TABLE 2

| Column | | |
|---|---|---|
| Heading | Source Table | Source Field |
| Descrip- | PRODUCTS | SHORT_DESCRIPTION |
| tion | | |
| Product | PRODUCTS | PRODUCT_ID |
| ID | | |
| Man- | PRODUCTS | MANUFACTURER |
| ufacturer | | |
| Mfg | PRODUCTS | MANUFACTURER_ITEM_NUMBER |
| Item No. | | |
| Prod. | PRODUCTS | PRODUCT_TYPE |
| Type | | |
| Prod. | PRODUCTIONS | PRODUCT_CLASS |
| Class | | |
| Check | None | Window action field |
| Avail- | | |
| ability | | |
| Add to | None | Window action field |
| Stock Plan | | |

As Table 2 indicates, client software can allow a customer to check product availability and add products to a stock plan. In a preferred embodiment, client software may make such functionality available for each record displayed. In an alternative embodiment, records may have check boxes or other selection controls, thereby allowing customers to check the availability of multiple items, and add multiple items to a stock plan.

When a customer checks availability of a product or products, the present invention may search Linked Supplier inventories to determine quantities available, physical location, anticipated delivery times, and the like. When inventory is available, client software may allow a customer to order a product.

When a customer chooses to add a product to an inventory or stocking plan, client software may request restocking and other parameters from a customer, then send appropriate information to a server. A server may add an appropriate entry to a Customer Inventory or other similar table, thereby enabling inventory tracking through the present invention.

Client software can also allow a customer to request a telephone call, an E-mail, or other contact from a sales consultant. In a preferred embodiment, a customer may select a product or supplier, and client software can query a server to determine an appropriate sales consultant for the selected product or supplier. A user can then be presented with a dialog box or other interactive interface which asks a customer to confirm a contact request. Once a contact request has been confirmed, client software may cause a server to store a request message in a Contact_Log table or other similar table.

In a preferred embodiment, a server may periodically scan Contact_Log table entries. When new or unanswered requests are found, a server may send a notification to a supplier alerting said supplier of such a request, where such a notification can include a customer E-mail address, telephone number, fax number, or other contact information, as well as other relevant customer and product information.

While the present invention can monitor inventory use and automatically order new inventory when necessary, a customer may anticipate a need for additional inventory based on parameters outside the scope of the present invention. By way of example, without intending to limit the present invention, if the present invention is used in a hospital, and the Olympics was held in or near the city in which the hospital is located, a hospital administrator may foresee the need to order additional quantities of frequently used supplies. Client software can provide a customer with the ability to quickly place such orders.

Customers can initiate such an order by clicking a button or otherwise interacting with a graphical or physical interface. In a preferred embodiment, a customer may select from products or groups of products already included in an inventory or stocking plan, or a customer may search for products through an interface similar to that described earlier. As previously described, customers can designate standard restocking quantities, and client software may use such quantities as defaults when clients are requesting additional inventory. Client software may also present quantities on hand to help customers make smarter purchasing decisions. Based on such information, customers can modify order quantities before submitting an order.

Client software can transmit customer orders to a server. Upon receipt of a customer order, a server can initiate an order fulfillment process.

A server may also automatically place an order based on customer demand. A server may periodically scan a customer inventory table and monitor inventory usage. As inventory is depleted, a server can predict frequently used items, and order appropriate quantities. Initially, a server may order limited quantities, to limit customer costs. A server may increase order quantities for frequently ordered products as customer usage habits dictate. A server may also construct an historical usage characterization, so that seasonal or other periodic usage patterns can be automatically taken into account.

As orders are placed, a server can query Linked Supplier inventories to determine each supplier's ability to fulfill an order. A server can calculate shipping costs as each order is processed, and a server can select one or more suppliers who can most cost effectively meet customer needs. As qualified suppliers are identified, orders are placed which can include expedited delivery and other options as specified by a customer or as determined by a server.

A server can also post supplier invoices to an accounts payable system, generate customer invoices based on supplier invoices, post customer invoices to an accounts receivable system. A server may further integrate with an automated payment system, thereby limiting invoicing and other such expenses.

In addition to customer and order related functions, a server can also provide administrative functions. By way of example, without intending to limit the present invention, a user who is not a customer can register to be a customer through a server-provided interface. Such an interface may allow a user to specify a business name, business type, executive director or general manager, physical address, mailing address, shipping address, one or more telephone numbers, employee names, employee licensing and accreditation information, and the like.

As users submit such information, a server may validate that an address, telephone number, and zip code are all valid with respect to each other, and that all necessary fields have been filled. If any validations fail, a server may present a data entry page along with any invalid data, thus simplifying data correction.

A server and client software may also allow customers and suppliers to change various information. By way of example, without intending to limit the present invention, suppliers can change pricing; add or remove vendors and products; add,

edit, or remove contacts; view account status and open invoices; and perform other such functions. Customers can adjust inventory counts to reflect audit results; add, edit, or remove employees and employee information; update payment and contact information; view account balances and make payments; and perform other such functions.

Linked Suppliers can also take advantage of many of these same features. Linked Suppliers implementing the present invention can track inventory; provide real-time inventory information to prospective customers; accept electronic orders; generate pick/pack lists; track order fulfillment process, including tracking into which containers each item in an order has been placed; generate bar-coded packing lists and shipping labels for each container; and generate invoices.

The present invention also provides Linked Suppliers with other advantages over the prior art. By way of example, without intending to limit the present invention, Linked Supplier inventory needs can be forecast based on prior order history, prior lead times, safety stock quantities, and the like, thereby reducing overall inventory investment. The present invention can also allow enable a Linked Supplier to track processing and shipping status for various products within an order, thereby providing a higher level of customer service. The present invention may also allow managers or other authorized individuals to electronically sign a purchase order, invoice, or other billing or order document and electronically transmit such a document to an appropriate recipient.

To achieve the functionality set forth above, a preferred embodiment of the present invention includes the following table structure. The table structure described below is included for enablement and best mode purposes, and should not be construed as limiting the present invention.

Table Name—

Client Control

Table Description and function—This table can reside locally on a customer computer. It can store one or more records containing control data needed to manage on and off-line functions remotely. These records can be updated via an update applet transferring data from the Web Server's SQL database to this control. Its purpose is to provide control over the processes running on the local machine even if it is off-line, and to enable it to reconnect automatically.

| Column (field) Name | Description |
|---|---|
| CUSTOMER_ID | Customer ID - matches Customer ID in |
| | CUSTOMERS data in the Web Server SQL Database |
| IP_ADDRESS | This is the IP address for this machine |
| DSL_PORT | Connection path or port (e.g., COM2) where DSL |
| | connection exists; null if there is no DSL line for this |
| | machine |
| DIAL_PORT | Connection path ro port (e.g., COM3) where dial-up |
| | connection exists; null if there is no dial-up connection |
| | for this machine |
| DIAL_CONNECTION_PHONE | Phone number the software dials to establish a dial-up |
| | connection to the Web server system. Null if there is |
| | no dial-up connection |
| DIAL_CALL_BACK | Phone number of the dial-up line; to allow call-back |
| | from the web server. |

Table Name -
CLIENT ERROR_LOG

Table Description and function—This table contains an error generation history for processes originating on a customer machine. It can provide an audit trail and view of how well processes are functioning, and a place to record both fatal-error conditions and those that may not need to be displayed to customers. Its data may not be processed, but can be stored for review by system administrators and managers.

| Column (field) | | Field Characteristics |
|---|---|---|
| Name | Description | & Indexing |
| ERROR_DATE | Date of error log entry | Index - |
| | | concatenated with |
| | | ERROR_TIME |
| ERROR_TIME | Time of error log entry | Index - |
| | | with |
| | | ERROR_DATE |
| CALLER | Program name generating | |
| | the error log entry | |
| ERROR_MESSAGE | Error message generated by | |
| | the caller program | |
| USER_VIEWABLE | Yes - if message also | |
| | displayed on user seen | |
| | page; No if internal only | |
| | message | |
| DATA_DUMP | Data (if any) causing the | |
| | error | |

Table Name -
SYSTEM ERROR_LOG

Table Description and function—This table can contain a history of errors generated by processes originating from outside a customer machine. The table can provide an audit trail and view of how well processes are functioning, and provide a place to record both fatal and non-fatal errors. Such data can allow system administrators, programmers, and managers to monitor automated, unattended processes. SYSTEM_ERROR_LOG can use a data dictionary/field structure similar to a Client_Error_Log table.

| Column (field) | | Field Characteristics |
|---|---|---|
| Name | Description | & Indexing |
| ERROR_DATE | Date of error log entry | Index - |
| | | concatenated with |
| | | ERROR_TIME |
| ERROR_TIME | Time of error log entry | Index - with |
| | | ERROR_DATE |
| CALLER | Program name generating | |
| | the error log entry | |
| ERROR_MESSAGE | Error message generated | |
| | by the caller program | |
| USER_VIEWABLE | Yes - if message also | |
| | displayed on user seen | |
| | page; No if internal only | |
| | message | |
| DATA_DUMP | Data (if any) causing the | |
| | error | |

Table Name -
SYS_PARAMETERS

Table Description and function—Stores system-wide parameters in a common table.

| Column (field) | | |
|---|---|---|
| Name | Description | Field Characteristics & Indexing |
| PARAM_ID | Identifies parameter | Primary Index |
| VAR1 | First variable | |
| VAR2 | Second variable | |
| VAR3 | Third variable | |

Table Name -
CUSTOMER APPLICATION

Table Description and function—this table can have a data dictionary similar to the CUSTOMERS table, and can be used to temporarily store unapproved, unprocessed customer application data submitted by a Customer/Client Application page. When an application is processed, appropriate records can be deleted from this table.

| | | |
|---|---|---|
| Column (field) | | |
| Name | Description | Field Characteristics & Indexing |

See CUSTOMERS

Table Name -
MEMBERS APPLICTIONS

Table Description and function—this table has may use a data dictionary similar to PRACTICE MEMBERS, and can temporarily store unapproved, unprocessed customer application data submitted by a Customer/Client Application page. When an application is processed, appropriate records can be deleted from this table.

| | | |
|---|---|---|
| | | Field |
| Column (field) Name | Description | Characteristics & Indexing |

See
PRACTICE_MEMBERS

Table Name -
CUSTOMERS

Table Description and function—Can store a unique identifier for each customer in a permanent table. Activity logged in CUSTOMER_MAINT_HISTORY table. Can be linked to third-party applications for credit terms, bill to, ship to addresses, phones and other financial data.

| | | | Field |
|---|---|---|---|
| | | | Characteristics |
| Column (field) Name | Description | Comment | & Indexing |
| CUSTOMER | Identifies | Unique identifier | Primary Index |
| | customer | (account number); | |
| | | matches | |
| | | CUSTOMER in A/R | |
| | | system | |
| NAME | Practice Business | See Practice | Index |
| | Name | Members for doctor | |
| | | data. | |
| SALES_CONSULTANT | Identifies sales | | Index |
| | consultant | | |
| | assigned to | | |
| | account | | |
| IPADDRESS1 | Internet address | Can have multiple | |
| | used to link, | computers in larger | |
| | identify | offices. | |
| | computers in | | |
| | customers office | | |
| IPADDRESS2 | Internet address | Can have multiple | |
| | used to link, | computers in larger | |
| | identify | offices. | |
| | computers in | | |
| | customers office | | |
| IPADDRESS3 | Internet address | Can have multiple | |
| | used to link, | computers in larger | |
| | identify | offices. | |
| | computers in | | |
| | customers office | | |
| IPADDRESS4 | Internet address | Can have multiple | |
| | used to link, | computers in larger | |
| | identify | offices. | |
| | computers in | | |
| | customers office | | |
| DISCOUNT_CODE | Identifies which | Code must be in | Index |
| | discount code is | DISCOUNT_CODES | |
| | used to calculate | table. | |
| | prices charged for | | |
| | this customer | | |
| PHYSICAL_ADDRESS | Street address of | | |
| | practice | | |
| PHYSICAL_STATE | State in which the | | |
| | practice is located | | |
| PHYSICAL_ZIP | Zip code of | | |
| | physical location | | |
| | of practice | | |
| SHIP_TO_ADDRESS | Address to which | | |
| | shipments go | | |
| SHIP_TO_STATE | State for ship to | | |
| | address | | |
| SHIP_TO_ZIP | Zip code for ship | | |
| | to address | | |
| MAIL_ADDRESS | Mailing address | Literature, documents | |
| | (for other than | only (may be a PO | |
| | shipments) | Box to which UPS & | |
| | | FedEx cannot ship) | |
| MAIL_STATE | Mail address state | | |
| MAIL_ZIP | Zip code for mail | | |
| | address | | |
| ADMINISTRATOR | Administrator, | | |
| | manager, etc. of | | |
| | Customer | | |

Table Name -
PRACTICE_MEMBERS

Table Description and function—This table can be linked to records in a CUSTOMERS table, and can store data pertaining to individual physicians or other health-care professionals working at or with a practice.

| | | | Field |
|---|---|---|---|
| | | | Characteristics |
| Column (field) Name | Description | Comment | & Indexing |
| CUSTOMER | Customer to | Must be in | Index - |
| | whom the | CUSTOMERS table | concatenated |
| | Practice Member | already | with |
| | is associated | | MEMBER_NAME |
| MEMBER_NAME | Name of health- | Together with | With |
| | care professional | CUSTOMER, forms | CUSTOMER |
| | or physician | unique record key | |
| | linked to | | |
| | CUSTOMER | | |
| MEMBER_TITLE | Title (e.g., Exec. | | |
| | Director) of | | |
| | member | | |
| MEMBER_MAIL_ADDRESS | Separate mailing | | |
| | address for | | |
| | member | | |
| MEMBER_MAIL_STATE | Member mail | | |
| | address state | | |
| MEMBER_MAIL_ZIP | Member mail | | |
| | address zip | | |
| MEMBER_LICENSE_NO | Professional | | |
| | license for | | |
| | member | | |
| MEMBER_LICENSE_EXPIRE | Expiration Date | | |
| | of member's | | |
| | professional | | |
| | license | | |
| MEMBER_DEGREE1 | First degree of | | |
| | member | | |
| MEMBER_DEGREE2 | Second degree of | | |
| | member | | |
| MEMBER_DEGREE3 | Third degree of | | |
| | member | | |
| MEMBER_DEGREE4 | Fourth degree of | | |
| | member | | |
| MEMBER_NOTES | Text/comment | | |
| | field | | |
| DATE_NEW | Date this member | | |
| | was added to | | |
| | table | | |
| DATE_LAST | Last activity date | | |

Table Name -
DISCOUNT_CODES

Table Description and function—can contain decimal values representing a unique price to be charged or discount to be granted to each customer. Any number of customers may use a discount code. When a decimal value associated with a given code is changed, the result is that all prices for all customers using that code are changed. If a customer's discount code specifies a discount value greater than allowed for a given product, the present invention may limit a price to the maximum discount

| Column (field) | | | Field Characteristics |
|---|---|---|---|
| Name | Description | Comment | & Indexing |
| DISC_CODE | Discount code | Identifies specific | Primary Index |
| | | discount; numbering | |
| | | should be 10, 20, 30, | |
| | | etc. to allow for | |
| | | insertions in future, | |
| | | e.g, 14 | |
| DISC_VALUE | Decimal value for | | |
| | the discount to be | | |
| | given. | | |
| NOTES | Notes; text field for | | |
| | commentary about a | | |
| | particular discount code | | |

Table Name -
CUSTOMER_INVENTORY

Table Description and function—stores inventory at customer office. One record for each customer/SKU combination, including all that have been used in past, or which are to be used for next ordering cycle. Permanent table. Activity logged in CUSTOMER_INVENTORY_TX table.

| Column (field) | | | Field Characteristics |
|---|---|---|---|
| Name | Description | Comment | & Indexing |
| CUSTOMER | Identifies customer | | Index - |
| | | | concatenated with |
| | | | PRODUCT |
| PRODUCT | Identifies product at | | Indexed with |
| | customer's site | | CUSTOMER |
| ON_HAND_QTY | Quantity of an item | | |
| | on hand at this | | |
| | customer | | |
| ROP | Reorder point | When on_hand_qty | |
| | quantity | falls to or below this | |
| | | quantity, a new | |
| | | order is triggered for | |
| | | the product. | |
| ROQ | Quantity to be | Ordering process | |
| | ordered | uses this quantity | |
| | | when a product is | |
| | | “triggered” | |
| STATUS | Activity status of | Values: | Index |
| | item | Active (default, | |
| | | normal setting) | |
| | | NoOrder (continue | |
| | | to use up inventory, | |
| | | but no more orders) | |
| | | NoUse (do not | |
| | | accept scanned | |
| | | usage of product) | |

Table Name -
PRODUCTS

Table Description and function—identifies products available for sale at any point in time. Includes products no longer active. One record for each product/SKU/Item Number.

| | | | Field Characteristics |
|---|---|---|---|
| Column (field) Name | Description | Comment | & Indexing |
| PRODUCT_ID | Identifies | | Primary Index |
| | product; SKU; | | |
| | also is“item | | |
| | number” | | |
| SHORT_DESCRIPTION | Short description | | Index |
| | appearing on | | |
| | most printed | | |
| | outputs & | | |
| | screens | | |
| LONG_DESCRIPION | Long description | | Index, built so each |
| | for additional | | word is indexed |
| | description | | separately. |
| MANUFACTURER | Company | | Index |
| | making product; | | |
| | Must be in | | |
| | MANUFACTURERS | | |
| | table | | |
| MANUFACTURER_ITEM_NUMBER | Manufacturer's | | Index |
| | product identifier | | |
| STATUS | Item status | Values: | |
| | | Active (default, | |
| | | normal usage) | |
| | | NoOrder (accept | |
| | | usage scans, no | |
| | | orders) | |
| | | NoUse (do not | |
| | | accept usage scans; | |
| | | no activity; obsolete | |
| | | or discontinued) | |
| PRODUCT_CLASS | Marketing/sales | | Index |
| | classification of | | |
| | product | | |
| PRODUCT_GROUP | Commodity | | Index |
| | classification of | | |
| | product | | |
| PRODUCT_LINE | Financial | | Index |
| | reporting | | |
| | classification of | | |
| | product | | |
| SELL_START_DATE | Date that new | Prior to this date | |
| | orders for this | orders will not be | |
| | product can be | processed (new | |
| | processed | product so not | |
| | | available yet) | |
| SELL_END_DATE | Date after which | After or on this date, | |
| | new orders for | orders will not be | |
| | this product | processed | |
| | cannot be | (discontinued | |
| | processed | product) | |
| PRODUCT_PICTURE | Product Picture | JPEG or GIF | |
| | bit map image | | |

Table Name -
MANUFACTURERs

Table Description and function—This table stores all manufacturers whose products may be carried in the PRODUCTS table. It serves as a reference and validation table for products.

| Column (field) | | | Field Characteristics |
|---|---|---|---|
| Name | Description | Comment | & Indexing |
| MANUFACTURER_ID | Short abbreviation | | Primary Index |
| | for manufacturer | | |
| MANUFACTURER_NAME | Normal business | | Indexed |
| | name for | | |
| | manufacturer | | |
| DATE_ADDED | Date this | | |
| | Manufacturer was | | |
| | added to the table | | |

Table Name -
ORDERS

Table Description and function—stores orders generated by nightly process and/or by critical ordering process, which are then downloaded to distributor. Serves as order “header” record. Linked to ORDER DETAIL table where line items are stored. No maintenance history log table. One record for each order generated and downloaded.

| Column (field) | | | Field Characteristics |
|---|---|---|---|
| Name | Description | Comment | & Indexing |
| ORDER_NO | Order Number; | Generated by | Primary Index |
| | unique identifier for | ordering processes; | |
| | the order | increments | |
| | | SYSTEM_PARAMTER | |
| | | for order | |
| | | number | |
| ORDER_DATE | Date order | | Index |
| | generated | | |
| ORDER_TIME | Time order | | |
| | generated | | |
| ORDER_SOURCE | How order was | Sources are: | |
| | generated | AUTO - nightly | |
| | | process | |
| | | MANUAL - | |
| | | manual order | |
| | | entered on terminal | |
| | | in customer's office. | |
| CUSTOMER | Customer on the | | Index |
| | order | | |
| LINKED_SUPPLIER | Linked Supplier to | | Index |
| | whom the order was | | |
| | downloaded | | |
| ORDER_STATUS | Status of the order; | Values: | Index |
| | shows latest status | GEN - generated | |
| | only, sequence is | PLACED - | |
| | presumed | downloaded to | |
| | | supplier | |
| | | S_BILLED - | |
| | | supplier has | |
| | | invoiced Med-e- | |
| | | Track | |
| | | C_BILLED - | |
| | | system has | |
| | | converted supplier | |
| | | invoice to customer | |
| | | invoices | |
| STATUS_DATE | Date which status | | |
| | changed | | |
| SHIP_TO_ADDRESS | Address to which | | |
| | orders is to be | | |
| | shipped; appears on | | |
| | downloaded order | | |
| | data | | |
| ORDER_PRODUCT_TOTAL | Total value of order | | |
| | for product only; not | | |
| | including tax, | | |
| | shipping, other | | |
| | charges | | |

Table Name -
ORDER_DETAIL

Table Description and function—stores line item detail on ORDERS. One record for each line item on an order.

| | | | Field |
|---|---|---|---|
| | | | Characteristics & |
| Column (field) Name | Description | Comment | Indexing |
| ORDER_DTL_ORDER_NO | Order number to | | Index - |
| | which this detail | | concatenated with |
| | record belongs | | ORDER_LINE_NUMBER |
| ORDER_LINE_NUMBER | Line number for | With | |
| | order. | Order_Dtl_Order_no, | |
| | | forms | |
| | | a unique | |
| | | identifier | |
| PRODUCT | Product identifier | | Index |
| | for item ordered | | |
| ORDER_QUANTITY | Quantity of the | | |
| | product that is | | |
| | being ordered. | | |
| SHIP_QUANTITY | Quantity of the | | |
| | item shipped; as | | |
| | reflected on an | | |
| | uploaded, | | |
| | processed | | |
| | supplier | | |
| | invoice/packlist | | |
| CUSTOMER_UNIT_PRICE | Price to be | | |
| | charged to | | |
| | customer | | |
| CUSTOMER_UNI_SALES_TAX | Sales tax, if any | | |
| | to be charged | | |
| | customer | | |
| PRODUCT_ORDERED_SUBTOTAL | Value = Order_Quantity * | | |
| | Customer_Unit_price | | |
| PRODUCT_SHIP_SUBTOTAL | Value = Ship_Quantity * | | |
| | Customer Unit_Price | | |
| LINKED_SUPPLIER_UNIT_COST | Price to be paid | | |
| | Linked Supplier | | |
| | for this item | | |
| LINKED_SUPPLIER_PRODUCT_SHIP_SUBTOTAL | Value = Ship_Quantity * | | |
| | Linked_Supplier_Unit_cost | | |

Table Name -
LINKED SUPPLIER

Table Description and function—Stores and sets up each linked supplier, i.e., distributor that is linked into the web site. One record for each supplier that will be, is now, or has been linked at one time into Med-e-Track. Activity logged in LINKED_SUPPLIER MAINT_HISTORY. Account is linked to Supplier table in the SOLOMAN Accounts Payable subsystem.

| Column (field) Name | Description | Comment |
|---|---|---|
| SUPPLIER | Supplier's ID | Unique |
| | | identifier |
| SUPPLIER_IP_ADDRESS | IP Address where linking | |
| | process occurs | |
| OPEN_DATE | Date the relationship was | |
| | setup/started | |

Table Name -
SUPPLIER INVOICE

Table Description and function—stores uploaded invoice/pack lists from linked suppliers. Serves as “header” record for invoices. A given Order can have multiple invoices. Linked to SUPPLIER INVOICE DETAIL records which carry line item detail. Invoices uploaded from distributor reflect orders they have shipped and are then used to generate Customer invoices. The uploaded invoice data is also transferred to the Accounts Payable module of the Solomon IV software for corporate accounting/tracking. Customer invoices generated and recorded in this table are also transferred to the Accounts Receivable module.

| Column (field) | | | Field Characteristics |
|---|---|---|---|
| Name | Description | Comment | & Indexing |
| INTERNAL_INVOICE_ID | Internal, system | Insures unique | |
| | generated invoice | invoice | |
| | identifier | identification in | |
| | | case of similar | |
| | | supplier invoicing | |
| | | schemes/numbers | |
| ORDER | Order number | | |
| | which the invoice is | | |
| | a shipment/bill for. | | |
| SUPPLIER_INVOICE | Invoice identifier | Uploaded invoice | |
| | from supplier | data | |
| SUPPLIER_INVOICE_DATE | Date of/on supplier | | |
| | invoice that was | | |
| | uploaded | | |
| SUPPLIER_INVOICE_TIME | Time that supplier | Invoice time may | |
| | invoice was | not appear in | |
| | uploaded | supplier database. | |
| AP_DATE | Date supplier | | |
| | invoice data posted | | |
| | to AP tables | | |
| AP_TIME | Time supplier | | |
| | invoice data was | | |
| | posted to AP tables | | |
| CUSTOMER_INVOICE | Invoice ID | Presence indicates | |
| | generated by nightly | that nightly process | |
| | process to bill | has run, generating | |
| | customer for | this separate invoice | |
| | shipment | number. | |
| CUSTOMER_INVOICE_DATE | Date customer | | |
| | invoice generated | | |
| | by nightly process | | |
| CUSTOMER_INVOICE_TIME | Time of customer | | |
| | invoice generation | | |
| | process. | | |
| AR_DATE | Time | | |
| SHIPMENT | Shipment document | May be separate ID | Index on this field |
| | number | from invoice no. | for packing slip data |
| | | | retrieval. |
| SHIP_VIA | Shipping method; | | |
| | e.g., UPS Ground | | |

Table Name -
INTERNAL_INVOICE_SHIP_DETAIL

Table Description and function—This table contains shipment information for the shipment covered by the Internal Invoice. There is one record for each carton comprising the shipment covered by the Invoice. It is linked to the Internal Invoice table.

| Column (field) Name | Comment |
|---|---|
| INTERNAL_INVOICE_ID | |
| SHIP_CARTON_ID | Together with invoice id, |
| | comprises unique record ID |
| TRACKER_NO | |

Table Name -
SUPPLIER_INVOICE_DETAIL

Table Description and function—this table carries the line item level detail for invoices uploaded from the linked supplier/distributor. Some line item level detail is used to update Order data to support quick order status inquiries and track back-ordered items.

| Column (field) Name | Description | Comment |
|---|---|---|
| INTERNAL_INVOICE_ID | Identifier for internal | |
| | invoice no | |
| INTERNAL_INVOICE_LINE_NUMBER | Line number for internal | Together with Internal |
| | invoice | Invoice identifier, forms |
| | | unique key |
| SHIPPED_PRODUCT | Product shipped | |
| SHIP_QUANTITY | Quantity shipped | |
| UNIT_PRICE | Supplier's Unit price | |
| UNIT_TAX | Sales Tax (if any) | |
| EXTENDED_PRICE | Value = Ship_qty * Unit_Price | Product only subtotal |
| LINE_TAX_TOTAL | Value = Ship_Qty * Unit_Tax | |
| LINE_TOTAL_AMOUNT | EXTENDED_PRICE + | |
| | Line_Tax_total | |

Table Name -
SUPPLIER_COST

Table Description and function—Stores prices to be paid to each Linked Supplier in the system. One record for each linked supplier and SKU. Permanent table. Activity logged in SUPPLIER_COST_MAINT_HISTORY table.

| | | | |
|---|---|---|---|
| Column (field) | Description | Comment | Field Characteristics |
| Name | | | & Indexing |

Table Name -

SUPPLIER_COST_MAINT_HISTORY

Table Description and function—records changes made to SUPPLIER_COST records. One record for each field changed during an update of a given record.

| | | | |
|---|---|---|---|
| Column (field) | Description | Comment | Field Characteristics |
| Name | | | & Indexing |

Table Name -

PRODUCT_MAINT_HISTORY

Table Description and function—records changes made to PRODUCTS table. One record for each field changed during an update of a given record.

| | | | |
|---|---|---|---|
| Column (field) | Description | Comment | Field Characteristics |
| Name | | | & Indexing |

Table Name -

PRODUCT CLASS

Table Description and function—Identifies valid product classes; serves as a reference table.

| Column (field) Name | Description |
|---|---|
| PROD_CLASS_CODE | Code for product class description |
| DESCRIPTION | Text/descriptive name for product_class code |

Table Name -

PRODUCT GROUP

Table Description and function—Identifies valid product groups; serves as a reference table.

| Column (field) Name | Description |
|---|---|
| PRODUCT_GROUP_CODE | Code for product group description |
| DESCRIPTION | Text/descriptive name for Product |
| | Group Code. |

Table Name -

PRODUCT_LINE

Table Description and function—Identifies valid product lines; serves as a reference table.

| Column (field) Name | Description |
|---|---|
| PRODUCT_LINE_CODE | Code for product line description |
| DESCRIPION | Text/descriptive name for product line |
| | code |

Table Name -

CUSTOMER INVENTORY TRANSACTIONS

Table Description and function—transaction history table for activity altering data in Customer Inventory table; one record for each change recorded; main use will be recording inventory activity, although transactions will be generated for changes to status, ROP, ROQ and Notes values, i.e., non-on-hand quantity values. Each transaction affects only one data field. Transaction code indicates what update/change activity was performed, and therefore which data field was updated.

| Column (field) | | |
|---|---|---|
| Name | Description | Comment |
| TRAN_NO | Unique identifier for each | Functions like a |
| | transaction; non significant | check number. |
| TRAN_DATE | Date transaction processed | |
| TRAN_TIME | Time transaction processed | |
| TRAN_ID | Code identifying transaction | Values: |
| | | TBD |
| PRODUCT | Product identifier of item | |
| | affected | |
| QTY | | |
| CUSTOMER | Customer whose inventory data | |
| | was updated/changed | |
| USER_ID | User performing transaction | |
| BEFORE_VALUE | Value of data field prior to | |
| | update action | |
| AFTER_VALUE | Value of data field after update | |
| | action | |

Table Description and function—this table accepts transactions from the consultant request function, enters and tracks them for followup and management purposes.

| Column (field) Name | Description |
|---|---|
| SALES_CONSULTANT_ID | ID in Sales_Consultants table. |
| REQUEST_DATE | Date customer initiated request |
| REQUEST_TIME | Time customer initiated request |

Table Description and function—This table stores information about each user at a customer's site. There are two classes of users, supervisor and staff. Only a user with supervisor rights can add new users. The web page “hard-wires” who the customer is so customer users are kept associated with the correct customer.

| | | | |
|---|---|---|---|
| Column (field) | Description | Comment | Field Characteristics |
| Name | | | & Indexing |

Table Description and function—This table stores data about each Sales Consultant. It is essentially a reference table.

| Column (field) Name | Description |
|---|---|
| SALES_CONSULTANT_ID | Unique identifier * record key |
| CONSULANT_SHORT_NAME | Short name, nicknemame, |
| | initials to be used |
| | on screens, reports |
| CONSULTANT_FULL_FIRST_NAME | First name of consultant |
| CONSULTANT_LAST_NAME | Last name of consultant |

It should be obvious to one skilled in the art that the present invention allows inventory tracking and management through a combination of manual, semi-automated, and automated means. The present invention also allows a manager to purchase in bulk and take advantage of promotions and other special offerings, thus reducing inventory costs. In addition, the present invention reduces the amount of inventory which must be kept on-hand by accurately modeling and predicting inventory needs. The present invention further provides customers with the ability to review new equipment, communicate with each other, and buy and sell excess inventory, refurbished equipment, and the like.

While the preferred embodiment and various alternative embodiments of the present invention have been disclosed and described in detail herein, it may be apparent to those skilled in the art that various changes in form and detail may be made therein without departing from the spirit and scope thereof, including applying the present invention to fields other than healthcare.

Thus, the preferred inventory management relates to an inventory management system comprising:

one or more computers;

one or more databases residing on said computers, in which inventory information is stored;

client software providing an interface to said database and performing administrative functions;

a user identification subsystem;
a first subsystem, through which new products can be added to said database, and which enables proper accounting of restocked products within said database; and
a second subsystem, which accounts for products within said database as such products are removed from inventory;
a third subsystem, wherein the third subsystem allows at least one vendor to access the database; and
a fourth subsystem, wherein the fourth subsystem allows for automated product identity data entry.

In one aspect of the inventive subject matter, said one or more of said subsystems are comprised of an optical reader which can read specially coded information on an object or person.

In another aspect of the inventive subject matter, said one or more of said subsystems are comprised of an electronic device for scanning wirelessly accessible-identifiers associated with objects or persons.

In an alternate aspect of the inventive subject matter, said user identification subsystem is comprised of a biometric identification device.

In a further aspect of the inventive subject matter, said client software permits registration and removal of individual users, and modification of user information.

In another aspect of the inventive subject matter, said client software allows users to be classified into groups, and where permissions or roles are assigned to such groups.

In yet another aspect of the inventive subject matter, said client software allows products to be grouped, allows restrictions to be placed on distribution of such products, permits recording of information when a product belonging to a group is dispensed, and allows printing of product specific or group specific information for inclusion with each product removed from inventory.

In an alternate aspect of the inventive subject matter, said client software monitors inventory levels and reports anticipated shortages.

In a further aspect of the inventive subject matter, said client software monitors inventory levels and generates orders to cover anticipated shortages.

In yet a further aspect of the inventive subject matter, said client software allows users to order new products or to supplement inventory when desired.

In another of the inventive subject matter, said client software allows users to specify a price for goods for sale within an inventory.

The preferred inventory management further relates to a vendor managed inventory system, comprising: one or more suppliers maintaining inventory utilizing an inventory management system; one or more customers maintaining inventory utilizing an inventory management system; a central server, which facilitates communications and inventory management between said customers and said suppliers; and, a redundant data connection between said suppliers, said customers, and said central server.

In one aspect of the inventive subject matter, said central server receives inventory information from customers and suppliers, anticipates inventory shortages, generates orders to cover such shortages, selects suppliers and products for such orders, places orders with selected suppliers, and monitors order status.

The preferred inventory management additionally relates to an inventory distribution system comprising: a vending machine; a computer connected to said vending machine; software running on said computer; a printer; a user identification subsystem; and a data entry subsystem.

In one aspect of the inventive subject matter, said user identification subsystem is comprised of a biometric scanner, RFID reader, barcode scanner, keyboard, touch sensitive display, or combinations thereof, and through which users can positively identify themselves to said computer via said software.

In another aspect of the inventive subject matter, said data entry subsystem is comprised of an active or passive user interface, and through which users can request dispensation of certain products.

In a further aspect of the inventive subject matter, said printer prints product information when requested and as necessary to satisfy applicable regulations.

In an alternate aspect of the inventive subject matter, said inventory distribution system further comprises a central server and a redundant data connection between said vending machine and said server.

In a preferred embodiment, said computer monitors distribution of products contained within said vending machine, transmits such distributions to said server via said redundant data connection, and through which said server can notify a vending machine service provider of any inventory shortages.

The preferred inventory management also relates to an automated method of inventory management involving the steps of: accounting for received products in an inventory; monitoring products as such products are removed from an inventory; calculating trends based on the frequency with which products are used; determining optimal product quantities for each order, such that shipping costs are reduced and price points for different quantities are taken into account while also reducing expenditures, ordering additional stock as needed; tracking said orders; calculating order fulfillment trends based on delivery times from each supplier and for each product; and, determining preferred suppliers based on such order fulfillment trends.

In one aspect of the inventive subject matter, said step of accounting for received products in an inventory involves electronically reading documentation supplied with each package and automatically updating inventory information to reflect package contents.

In another aspect of the inventive subject matter, said step of monitoring products as such products are removed from an inventory involves electronically reading a product identifier associated with a product or group of products.

In a further aspect of the inventive subject matter, said automated inventory management method further includes the step of identifying a user removing products from an inventory by electronically retrieving an identifier from said user.

In addition, the preferred inventory management relates to an automated order fulfillment method, comprising the steps of: receiving an availability and pricing request from a customer for one or more products; determining acceptable alternatives for said products based on customer preferences; determining quantities available, pricing, quantities necessary for a price break, and anticipated delivery times from one or more suppliers to meet said request, including any acceptable alternatives; selecting products, product quantities, and suppliers that provide the most value while still meeting customer inventory needs; generating product pick and pack slips for each supplier; recording products as they are “picked” from a supplier inventory; recording products as they are packed into shipping packages; generating package packing slips and shipping labels; correlating shipping and packing information; shipping said packages; and tracking said shipments.

In one aspect of the inventive subject matter, said picked products are recorded by electronically scanning identifiers associated with such products.

In a preferred embodiment, said picked products are recorded by electronically scanning identifiers associated with such products using a handheld computing device, to which a barcode scanner is attached.

In another aspect of the inventive subject matter, said step of recording products as they are packed further includes the step of scanning an identifier associated with a shipping package prior to scanning individual items packed into a shipping package.

In a further aspect of the inventive subject matter, said packing and shipping labels include a machine readable identifier.

The preferred inventory management further relates to a vendor managed inventory and group purchasing system, comprising: one or more servers; one or more databases running on said servers; client software running on one or more computers at a customer site, which is capable of monitoring customer inventories and reporting such information to said server via a redundant data communications connection; client software running on one or more computers at a supplier site, which is capable of monitoring product quantities on hand and supports multiple product prices depending on order quantities, and which is capable of transmitting such information to said server via a redundant data communications connection; and software running on said server that consolidates customer orders such that customer costs may be decreased by leveraging the consolidated order quantities.

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the following claims.

We claim:

1. A method for facilitating sales of inventory items, comprising the steps of:
(a) maintaining at least one database having information relating to an inventory item,
wherein said inventory item is listed by a plurality of sellers, and
wherein said information comprises at least availability information and location information for said inventory item, which is available for sale from at least one seller;
(b) permitting a buyer to input a search request to generate a search in said database(s) for current availability and current location of such inventory item; and
(c) generating a search result which provides said buyer with information comprising the availability and location of an inventory item which is actually available for sale by one or more sellers.

2. The method of claim 1, comprising the additional step of permitting said buyer to reserve, purchase, or reserve and purchase said inventory item at a location of said buyer's choosing.

3. The method of claim 1, wherein said database is updated in near real time to actual, current availability and current location information for said inventory item.

4. The method of claim 1, wherein said search request is generated automatically through a software interface to a third party database.

5. The method of claim 1, wherein said information further comprises price information for said inventory item.

6. The method of claim 1, wherein said information further comprises a price range for said inventory item.

7. The method of claim 1, wherein said information further comprises a description of one or more feature(s) of said inventory item.

8. The method of claim 1, wherein said location information is restricted to a specified proximity limit in relation to a specified location.

9. The method of claim 8, wherein said specified location is restricted by zip code, postal code, country code, telephone area code, address, or a combination thereof.

10. The method of claim 8, wherein said specified location is determined by a GPS device.

11. The method of claim 1, wherein said information further comprises identification of alternate items which are interchangeable with said inventory item.

12. The method of claim 1, wherein said inventory item is tracked by an RFID-enabled inventory tracking system.

13. The method of claim 1, wherein said buyer's search request is restricted according to limited or unlimited permissions, roles, or authorizations assigned by said seller.

14. The method of claim 1, comprising the additional steps of:
(d) webpage-by-webpage said buyers' search requests;
(e) generating an items searched report compiling information relating to said buyers' search requests; and
(f) providing said report to one or more of said sellers.

15. The method of claim 14, comprising one or more of the additional steps:
(g) forecasting the inventory needs of a seller based on inventory usage, inventory availability trends, said items searched report, or a combination thereof;
(h) ordering inventory for a seller based on inventory usage, inventory availability trends, said items searched report, or a combination thereof;
(i) presenting advertising to a buyer based on inventory usage, inventory availability, market trends, said items searched report, or a combination thereof;
(j) providing a seller incentive offer to a buyer based on inventory usage, inventory availability, said items searched report, or a combination thereof; or
(k) a combination thereof.

16. A method for facilitating sales of inventory items, comprising the steps of:
(a) maintaining at least one database having information relating to an inventory item,
wherein said inventory item is listed by a plurality of sellers,
wherein said inventory item is tracked by an RFID-enabled inventory tracking system, and
wherein said information comprises at least availability information and location information for said inventory item, which is available for sale from at least one seller;
(b) permitting a buyer to input a search request to generate a search in said database(s) for current availability and current location of such inventory item; and
(c) generating a search result which provides said buyer with information comprising the availability and location of an inventory item which is actually available for sale by one or more sellers.

17. The method of claim 16, comprising the additional step of permitting said buyer to reserve, purchase, or reserve and purchase said inventory item at a location of said buyer's choosing.

18. The method of claim 16, wherein said database is updated in near real time to actual, current availability and current location information for said inventory item.

19. The method of claim 16, wherein said search request is generated automatically through a software interface to a third party database.

20. The method of claim 16, wherein said information further comprises price information for said inventory item.

21. The method of claim 16, wherein said information further comprises a price range for said inventory item.

22. The method of claim 16, wherein said information further comprises a description of one or more feature(s) of said inventory item.

23. The method of claim 16, wherein said location information is restricted to a specified proximity limit in relation to a specified location.

24. The method of claim 23, wherein said specified location is restricted by zip code, postal code, country code, telephone area code, address, or a combination thereof.

25. The method of claim 23, wherein said specified location is determined by a GPS device.

26. The method of claim 16, wherein said information further comprises identification of alternate items which are interchangeable with said inventory item.

27. The method of claim 16, wherein said buyer's search request is restricted according to limited or unlimited permissions, roles, or authorizations assigned by said seller.

28. The method of claim 16, comprising the additional steps of:
(d) storing said buyers' search requests;
(e) generating an items searched report compiling information relating to said buyers' search requests; and
(f) providing said report to one or more of said sellers.

29. The method of claim 28, comprising one or more of the additional steps:
(g) forecasting the inventory needs of a seller based on inventory usage, inventory availability trends, said items searched report, or a combination thereof;
(h) ordering inventory for a seller based on inventory usage, inventory availability trends, said items searched report, or a combination thereof;
(i) presenting advertising to a buyer based on inventory usage, inventory availability, market trends, said items searched report, or a combination thereof;
(j) providing a seller incentive offer to a buyer based on inventory usage, inventory availability, said items searched report, or a combination thereof; or
(k) a combination thereof.

30. A system for facilitating sales of inventory items, comprising the following elements, operably connected:
(a) at least one database, in which at least the following data is stored: availability and location information for at least one inventory item, listed by a plurality of sellers;
maintaining at least one database having information relating to an inventory item,
wherein said inventory item is listed by sellers as being available for sale, and
wherein said information comprises at least availability information and location information for said inventory item, which is available for sale from at least one seller;
(b) software providing an interface for initiating a search request by a buyer;
(c) software for providing access to a search engine for executing said search request in at least one database;
(d) software for processing a search request and providing a search result comprising the availability and location of such inventory item which is actually available for sale by one or more sellers; and
(e) software for providing an interface for displaying the result of the search of said at least one database.

31. The system of claim 30, comprising the additional element of software providing an interface for permitting said buyer to reserve, purchase, or reserve and purchase said inventory item at a location of said buyer's choosing.

32. The system of claim 30, wherein said database is updated in near real time to actual, current availability and current location information for said inventory item.

33. The system of claim 30, wherein said search request is generated automatically through a software interface to a third party database.

34. The system of claim 30, wherein said search result further comprises price information for said inventory item.

35. The system of claim 30, wherein said search result further comprises a price range for said inventory item.

36. The system of claim 30, wherein said search result further comprises a description of one or more feature(s) of said inventory item.

37. The system of claim 30, wherein said location information is restricted to a specified proximity limit in relation to a specified location.

38. The system of claim 37, wherein said specified location is restricted by zip code, postal code, country code, telephone area code, address, or a combination thereof.

39. The system of claim 37, wherein said specified location is determined by a GPS device.

40. The system of claim 30, wherein said search result further comprises identification of alternate items which are interchangeable with said inventory item.

41. The system of claim 30, wherein said inventory item is tracked by an RFID-enabled inventory tracking system.

42. The system of claim 30, wherein said software providing an interface for initiating a search request by a buyer restricts a buyer's search according to limited or unlimited permissions, roles, or authorizations assigned by said seller.

43. The system of claim 30, comprising the additional elements of:
(d) memory, and software providing an interface for storing said search requests;
(e) software for generating an items searched report which compiles information relating to said search requests; and
(f) software providing an interface for providing said items searched report to one or more of said sellers.

44. The system of claim 43, comprising one or more of the following additional elements:
(g) software for forecasting the inventory needs of a seller based on inventory usage, inventory availability trends, said items searched report, or a combination thereof;
(h) software for ordering inventory for a seller based on inventory usage, inventory availability trends, said items searched report, or a combination thereof;
(i) software providing an interface for presenting advertising to a buyer based on inventory usage, inventory availability, market trends, said items searched report, or a combination thereof;
(j) software providing an interface for providing a seller incentive offer to a buyer based on inventory usage, inventory availability, market trends, said items searched report, or a combination thereof; or
(k) a combination thereof.

45. The system of claim 30, comprising the additional elements of memory, and software providing an interface for a buyer to save, retrieve, and re-initiate an individual search request made by said buyer.

46. The system of claim 30, wherein said software provides an interface for initiating a multiple item search request by a buyer.
